(19) United States
(12) Patent Application Publication
(10) Pub. No.: US 2024/0430969 A1
(43) Pub. Date: Dec. 26, 2024

(54) METHODS AND DEVICES FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 18/706,836

(22) PCT Filed: Nov. 3, 2021
(86) PCT No.: PCT/CN2021/128488

§ 371 Date: May 2, 2024

(51) Int. Cl. H04W 76/19; H04L 5/00; H04W 16/28; H04W 72/1268; H04W 72/1273; H04W 72/231; H04W 76/20

(52) U.S. Cl. CPC H04W 76/19; H04L 5/0051; H04W 16/28; H04W 72/1268; H04W 72/1273; H04W 72/231; H04W 76/20

(57) ABSTRACT

Embodiments of the present disclosure relate to methods, devices and computer storage media for communication. A method comprises receiving, at a terminal device, from a network device, at least one configuration for a first list of cells, wherein the first list of cells comprises a first cell and a second list of cells, and at least a first spatial reception parameter of the second list of cells refers to the first cell based on the at least one configuration; and performing a first beam failure recovery procedure on the first list of cells; or performing the first beam failure recovery procedure on the first cell, and performing a second beam failure recovery procedure on the second list of cells, wherein the second beam failure recovery procedure is same with or related to the first beam failure recovery procedure.

### TECHNICAL FIELD

Embodiments of the present disclosure generally relate to the field of telecommunication, and in particular, to methods, devices and computer storage media for communication.

### BACKGROUND

In the third generation partnership project (3GPP) meeting RAN #86, it is agreed to support enhancement on multi-beam operation, mainly targeting the frequency range 2 (FR2) while also applicable to the frequency range 1 (FR1). It is agreed to identify and specify features to facilitate more efficient (lower latency and overhead) downlink (DL) and uplink (UL) beam management for intra-cell and inter-cell. For example, it is proposed to support common beam(s) for data and control information transmission/reception for both DL and UL. It is also proposed to support a unified Transmission Configuration Indication (TCI) framework for DL and UL beam indication. Moreover, multi-input multi-output (MIMO) has been proposed, which includes features that facilitate utilization of a large number of antenna elements at a base station for both sub-6 GHZ and over 6-GHz frequency bands. Therefore, it is worth enhancing multi-beam operations.

### SUMMARY

In general, example embodiments of the present disclosure provide methods, devices and computer storage media for communication.

In a first aspect, there is provided a method of communication. The method comprises receiving, at a terminal device, from a network device, at least one configuration for a first list of cells, wherein the first list of cells comprises a first cell and a second list of cells, and at least a first spatial reception parameter of the second list of cells refers to the first cell based on the at least one configuration; and performing a first beam failure recovery procedure on the first list of cells; or performing the first beam failure recovery procedure on the first cell, and performing a second beam failure recovery procedure on the second list of cells, wherein the second beam failure recovery procedure is same with or related to the first beam failure recovery procedure.

In a second aspect, there is provided a method of communication. The method comprises transmitting, at a network device, to a terminal device, receiving, at a network device, to a terminal device, at least one configuration for a first list of cells, wherein the first list of cells comprises a first cell and a second list of cells, and at least a first spatial reception parameter of the second list of cells refers to the first cell based on the at least one configuration; transmitting an indication of a first transmission configuration indicator (TCI), and transmitting a first set of channels and/or reference signals based on the first spatial reception parameter on the first list of cells after or starting from an application timing, wherein the first spatial reception parameter is based on the first TCI.

In a third aspect, there is provided a method of communication. The method comprises receiving, at a terminal device, from a network device, at least one configuration for a set of transmission configuration indicator (TCI) states, wherein the set of TCI states comprises at least one of: a first subset of TCI states, wherein at least one reference signal (RS) in a TCI state of the first subset is associated with a first physical cell identity (ID); and a second subset of TCI states, wherein at least one RS in a TCI state of the second subset is associated with a second physical cell ID; performing a beam failure recovery procedure based on at least one of a first set of RS for beam failure detection and a first set of RS for candidate beam identification, in case of a first TCI state of the first subset is indicated; and performing a beam failure recovery procedure based on at least one of a second set of RS for beam failure detection and a second set of RS for candidate beam identification, in case of a second TCI state of the second subset is indicated.

In a fourth aspect, there is provided a method of communication. The method comprises transmitting, at a network device, to a terminal device, at least one configuration for a set of transmission configuration indicator (TCI) states, wherein the set of TCI states comprises at least one of: a first subset of TCI states, wherein at least one reference signal (RS) in a TCI state of the first subset is associated with a first physical cell identity (ID); and a second subset of TCI states, wherein at least one RS in a TCI state of the second subset is associated with a second physical cell ID, wherein the at least one configuration for the set of TCI states is configured for a first cell, wherein the first cell is associated with the first physical cell ID; transmitting at least one configuration for a first list of cells, wherein the first list of cells comprises the first cell and a second list of cells, and at least a first spatial reception parameter of the second list of cells refers to the first cell based on the at least one configuration for the first list of cells; in response to a first TCI state in the first subset is indicated, transmitting at least one downlink channel and/or receiving at least one uplink channel on at least one cell in the first list of cells based on the first TCI state after or starting from an application timing; and in response to a second TCI state in the second subset is indicated, performing no transmitting or receiving on the second list of cells after or starting from the application timing; or in response to a second TCI state in the second subset is indicated, transmitting at least one downlink channel and/or receiving at least one uplink channel on at least one cell in the second list of cells based on a latest or previous TCI state, wherein the latest or previous TCI state is associated with the first physical cell ID.

In a fifth aspect, there is provided a terminal device. The terminal device comprises circuitry configured to perform the method according to the above first aspect of the present disclosure.

In a sixth aspect, there is provided a network device. The network device comprises circuitry configured to perform the method according to the above second aspect of the present disclosure.

In a seventh aspect, there is provided a computer program product comprising machine-executable instructions. The machine-executable instructions, when being executed, cause a machine to perform the method according to the above first or second aspect of the present disclosure.

In an eighth aspect, there is provided a computer readable medium having instructions stored thereon. The instructions, when executed on at least one processor, causing the at least one processor to perform the method according to the above first or second aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates an example signaling chart in accordance with some embodiments of the present disclosure;

FIGS. 3A-3C illustrate examples of embodiments of the present disclosure;

FIGS. 4A-4B illustrate examples of embodiments of the present disclosure;

FIGS. 5A-5E illustrate examples of embodiments of the present disclosure;

FIGS. 6A-6B illustrate examples of embodiments of the present disclosure;

FIGS. 7A-7C illustrate examples of embodiments of the present disclosure;

FIG. 8 illustrates a flowchart of an example method in accordance with some embodiments of the present disclosure;

FIG. 9 illustrates a flowchart of an example method in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As described above, it has been proposed to evaluate and, if needed, specify beam management related enhancements for carrier aggregation (CA) and inter-cell beam management. However, how to solve beam failure recovery for CA and inter-cell beam management is a big challenge for a reliable communication.

Generally speaking, for uplink (UL) transmission, one TRP usually corresponds to one SRS resource set. As used herein, the term “single-TRP for UL” refers to that a single SRS resource set is used for performing related transmissions (such as, PUSCH transmissions), and the term “multi-TRP for UL” refers to that a plurality of SRS resource sets are used for performing related transmissions (such as, PUSCH transmissions).

As mentioned above, there are enhancements on multi-beam operation, mainly targeting FR2 while also applicable to FR1: a. Identify and specify features to facilitate more efficient (lower latency and overhead) DL/UL beam management for intra-cell and inter-cell scenarios to support higher UE speed and/or a larger number of configured TCI states: i. Common beam for data and control transmission/reception for DL and UL, especially for intra-band CA; ii. Unified TCI framework for DL and UL beam indication; iii. Enhancement on signaling mechanisms for the above features to improve latency and efficiency with more usage of dynamic control signaling (as opposed to RRC); iv. For inter-cell beam management, a UE can transmit to or receive from only a single cell (i.e. serving cell does not change when beam selection is done). This includes L1-only measurement/reporting (i.e. no L3 impact) and beam indication associated with cell(s) with any Physical Cell ID(s): The beam indication is based on Rel-17 unified TCI framework; The same beam measurement/reporting mechanism will be reused for inter-cell mTRP; This work shall only consider intra-Distributed Unit (intra-DU) and intra-frequency cases.

As mentioned above, there are enhancements on multi-beam operation, mainly targeting FR2 while also applicable to FR1: a. Identify and specify features to facilitate more efficient (lower latency and overhead) DL/UL beam management to support higher intra- and L1/L2-centric inter-cell mobility and/or a larger number of configured TCI states: i. Common beam for data and control transmission/reception for DL and UL, especially for intra-band CA; ii. Unified TCI framework for DL and UL beam indication; iii. Enhancement on signaling mechanisms for the above features to improve latency and efficiency with more usage of dynamic control signaling (as opposed to RRC).

It is proposed to support L1-based beam indication using at least UE-specific (unicast) DCI to indicate joint or separate DL/UL beam indication from the active TCI states. The existing DCI formats 1_1 and 1_2 are reused for beam indication and it supports a mechanism for UE to acknowledge successful decoding of beam indication. The ACK/NACK of the PDSCH scheduled by the DCI carrying the beam indication can be used as an ACK also for the DCI.

It is also proposed to support activation of one or more TCI states via medium access control (MAC) control element (CE) analogous to Release.15/16. At least for the single activated TCI state, the activated TCI state is applied.

For beam indication with Rel-17 unified TCI, support DCI format 1_1/1_2 without DL assignment, acknowledgement/negative acknowledgement (ACK/NACK) mechanism is used analogously to that for semi-persistent scheduling (SPS) PDSCH release with both type-1 and type-2 HARQ-ACK codebook. Upon a successful reception of the beam indication DCI, the UE reports an ACK.

For type-1 HARQ-ACK codebook, a location for the ACK information in the HARQ-ACK codebook is determined based on a virtual PDSCH indicated by the time domain resource allocation (TDRA) field in the beam indication DCI, based on the time domain allocation list configured for PDSCH. For type-2 HARQ-ACK codebook, a location for the ACK information in the HARQ-ACK codebook is determined according to the same rule for SPS release. The ACK is reported in a PUCCH k slots after the end of the PDCCH reception where k is indicated by the PDSCH-to-HARQ_feedback timing indicator field in the DCI format, or provided dl-DataToUL-ACK or dl-DataToUL-ACK-ForDCI-Format1-2-r16 if the PDSCH-to-HARQ_feedback timing indicator field is not present in the DCI.

When used for beam indication, configured scheduling-radio network temporary identifier (CS-RNTI) is used to scramble the CRC for the DCI. The values of the following DCI fields are set as follows: RV=all ‘1’s; MCS=all ‘1’s; NDI=0; and set to all ‘0’s for FDRA Type 0, or all ‘1’s for FDRA Type 1, or all ‘0’s for dynamicSwitch (same as in Table 10.2-4 of TS38.213).

The TCI field can be used to signal the following: 1) Joint DL/UL TCI state, 2) DL-only TCI state (for separate DL/UL TCI), 3) UL-only TCI state (for separate DL/UL TCI).

In addition, the following DCI fields are being used in Rel-16: identifier for DCI formats; carrier indicator; bandwidth part indicator; time domain resource assignment (TDRA); downlink assignment index (if configured); transmit power control (TPC) command for scheduled PUCCH; PUCCH resource indicator; PDSCH-to-HARQ_feedback timing indicator (if present). The remaining unused DCI fields and codepoints are reserved in Release 17.

It is also proposed to support UE to report whether or not to support TCI update by DCI format 1_1/1_2. For a UE supporting TCI update by DCI format 1_1/1_2, it must support TCI update by using DCI 1_1/1_2 with DL assignment, and support of the above feature for TCI update by DCI format 1_1/1_2 without DL assignment is UE optional.

On Rel-17 DCI-based beam indication, regarding application time of the beam indication, the first slot or the first subslot that is at least X ms or Y symbols after the last symbol of the acknowledgment of the joint or separate DL/UL beam indication.

In some embodiments, a slot comprises 14 or 12 Orthogonal Frequency Divided Multiplexing (OFDM) symbols. In some embodiments, a subslot comprises at least one of {2, 4, 7} OFDM symbols.

According to TS 38.212 section 7.3.1.2.2 Format 1_1, Transmission configuration indication-0 bit if higher layer parameter tci-PresentInDCI is not enabled; otherwise 3 bits as defined in Clause 5.1.5 of [6, TS38.214]. According to TS 38.212 section 7.3.1.2.3 Format 1_2, Transmission configuration indication-0 bit if higher layer parameter tci-PresentDCI-1-2 is not configured; otherwise 1 or 2 or 3 bits determined by higher layer parameter tci-PresentDCI-1-2 as defined in Clause 5.1.5 of [6, TS38.214].

The UE receives an activation command, as described in clause 6.1.3.14 of [10, TS 38.321], used to map up to 8 TCI states to the codepoints of the DCI field ‘Transmission Configuration Indication’ in one Component Carrier (CC)/DL Bandwidth Part (BWP) or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2. For example, if the number of bits for the DCI field ‘Transmission Configuration Indication’ of DCI format 1_2 or the number of bits of higher layer parameter tci-PresentDCI-1-2 is 1 bit, then S=2. For another example, if the number of bits for the DCI field ‘Transmission Configuration Indication’ of DCI format 1_2 or the number of bits of higher layer parameter tci-PresentDCI-1-2 is 2 bits, then S=4. For another example, if the number of bits for the DCI field ‘Transmission Configuration Indication’ of DCI format 1_2 or the number of bits of higher layer parameter tci-PresentDCI-1-2 is 3 bits, then S=8.

Moreover, DCI format 1_1/1_2 with and without DL assignment can be used for dynamic beam indication. If beam indication is indicated by DCI format with DL scheduling, ACK/NACK of PDSCH can be used to indicate ACK of the beam indication, and after an application timing, indicated beam can be applied.

Embodiments of the present disclosure provide a solution to solve the above problem and/or one or more of other potential problems. According to this solution, in response to a beam failure being detected by a terminal device on at least one cell in a group of cells, the terminal device may transmit a beam failure recovery request (BFRQ) to a network device, where the BFRQ comprises TRP and/or cell information related to the beam failure detected on the cell. For example, the TRP information may indicate at least one of the following: the number of TRPs related to the beam failure detected on the cell, a TRP index related to the beam failure detected on the cell, whether a new candidate beam is identified on a failed TRP, information about the new candidate beam if it is identified on the failed TRP, and so on. For another example, the BFRQ may include at least one of the following: the cell index or information of the group of cells related to the beam failure detected, whether a new candidate beam is identified on a failed cell or the group of cells, information about the new candidate beam if it is identified on the failed cell or the group of cells, and so on.

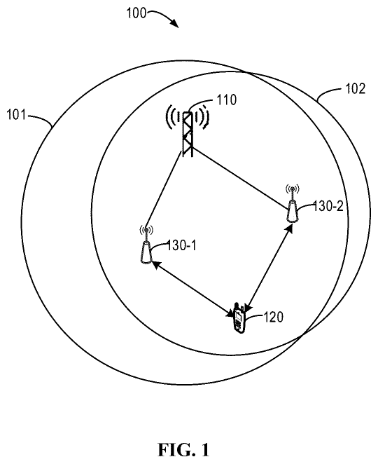

FIG. 1 shows an example communication network 100 in which embodiments of the present disclosure can be implemented. The network 100 includes a network device 110 and a terminal device 120 served by the network device 110. The network 100 may provide one or more serving cells to serve the terminal device 120.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 120.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Remote Radio Unit (RRU), a radio head (RH), a remote radio head (RRH), a low power node such as a femto node, a pico node, and the like.

The communication network 100 further comprises a network device 110. In the communication network 100, the network device 110 and the terminal devices 120 can communicate data and control information to each other. The numbers of devices shown in FIG. 1 are given for the purpose of illustration without suggesting any limitations.

In some scenarios, carrier aggregation (CA) can be supported in the network 100, in which two or more CCs are aggregated in order to support a broader bandwidth. For example, in FIG. 1, the network device 110 may provide to the terminal device 120 a plurality of serving cells including one primary cell (Pcell or Pscell or Spcell) 101 corresponding to a primary CC and at least one secondary cell (Scell) 102 corresponding to at least one secondary CC. It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

In some other scenarios, the terminal device 120 may establish connections with two different network devices (not shown in FIG. 1) and thus can utilize radio resources of the two network devices. The two network devices may be respectively defined as a master network device and a secondary network device. The master network device may provide a group of serving cells, which are also referred to as “Master Cell Group (MCG)”. The secondary network device may also provide a group of serving cells, which are also referred to as “Secondary Cell Group (SCG)”. For Dual Connectivity operation, a term “Special Cell (Spcell)” may refer to the Pcell of the MCG or the primary Scell (Pscell) of the SCG depending on if the terminal device 120 is associated to the MCG or the SCG, respectively. In other cases than the Dual Connectivity operation, the term “SpCell” may also refer to the PCell.

In one embodiment, the terminal device 120 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 120 from at least one of the first network device and the second network device. In one embodiment, first information may be transmitted to the terminal device 120 from the first network device and second information may be transmitted to the terminal device 120 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In the communication network 100 as shown in FIG. 1, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

In some embodiments, for downlink transmissions, the network device 110 may transmit control information via a PDCCH and/or transmit data via a PDSCH to the terminal device 120. Additionally, the network device 110 may transmit one or more reference signals (RSs) to the terminal device 120. The RS transmitted from the network device 110 to the terminal device 120 may also referred to as a “DL RS”. Examples of the DL RS may include but are not limited to Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and so on.

In some embodiments, for uplink transmissions, the terminal device 120 may transmit control information via a PUCCH and/or transmit data via a PUSCH to the network device 110. Additionally, the terminal device 120 may transmit one or more RSs to the network device 110. The RS transmitted from the terminal device 120 to the network device 110 may also referred to as a “UL RS”. Examples of the UL RS may include but are not limited to DMRS, CSI-RS, SRS, PTRS, fine time and frequency TRS and so on.

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, wireless local network communication protocols such as Institute for Electrical and Electronics Engineers (IEEE) 802.11 and the like. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

The network device 110 (such as, a gNB) may be equipped with one or more TRPs or antenna panels. As used herein, the term “TRP” refers to an antenna array (with one or more antenna elements) available to the network device located at a specific geographical location. For example, a network device may be coupled with multiple TRPs in different geographical locations to achieve better coverage. The one or more TRPs may be included in a same serving cell or different serving cells.

It is to be understood that the TRP can also be a panel, and the panel can also refer to an antenna array (with one or more antenna elements). Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

There are enhancements on multi-beam operation, mainly targeting FR2 while also applicable to FR1: a. Identify and specify features to facilitate more efficient (lower latency and overhead) DL/UL beam management to support higher intra- and L1/L2-centric inter-cell mobility and/or a larger number of configured TCI states: i. Common beam for data and control transmission/reception for DL and UL, especially for intra-band CA; ii. Unified TCI framework for DL and UL beam indication; iii. Enhancement on signaling mechanisms for the above features to improve latency and efficiency with more usage of dynamic control signaling (as opposed to RRC).

As shown in FIG. 1, for example, the network device 110 may communicate with the terminal device 120 via TRPs 130-1 and 130-2 (collectively referred to as “TRPs 130” or individually referred to as “TRP 130” in the following). For example, the TRP 130-1 may be also referred to as the first TRP, while the TRP 130-2 may be also referred to as the second TRP. As described above, the network device 110 may provide a group of cells to serve the terminal device 120. In some embodiments, the group of cells may be divided into a first subset of cells associated with the first TRP 130-1 and a second subset of cells associated with the second TRP 130-2. For example, the first subset of cells and the second subset of cells may include one or more overlapping cells or may not overlap each other.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHZ, an extending NR operation up to 71 GHz, narrow band-Internet of Thing (NB-IoT)/enhanced Machine Type Communication (cMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

It is to be understood that the numbers of network devices, terminal devices and/or TRPs are only for the purpose of illustration without suggesting any limitations to the present disclosure. The communication network 100 may include any suitable number of network devices, terminal devices and/or TRPs adapted for implementing implementations of the present disclosure.

In some embodiments, the TRPs may be explicitly associated with different higher-layer configured identities. For example, a higher-layer configured identity can be associated with a Control Resource Set (CORESET), a group of CORESETs, a reference signal (RS), a set of RS, a Transmission Configuration Indication (TCI) state or a group of TCI states, which is used to differentiate between transmissions between different TRPs and the terminal device 120. When the terminal device 120 receives two DCIs from two CORESETs which are associated with different higher-layer configured identities, the two DCIs may be transmitted or indicated from different TRPs. Further, the TRPs may be implicitly identified by a dedicated configuration to the physical channels or signals. For example, a dedicated CORESET, a RS, and a TCI state, which are associated with a TRP, are used to identify a transmission from a different TRP to the terminal device 120. For example, when the terminal device 120 receives a DCI from a dedicated CORESET, the DCI is indicated from the associated TRP dedicated by the CORESET. In some embodiments, the RS may be at least one of CSI-RS, SRS, positioning RS, uplink DM-RS, downlink DM-RS, uplink PTRS and downlink PTRS.

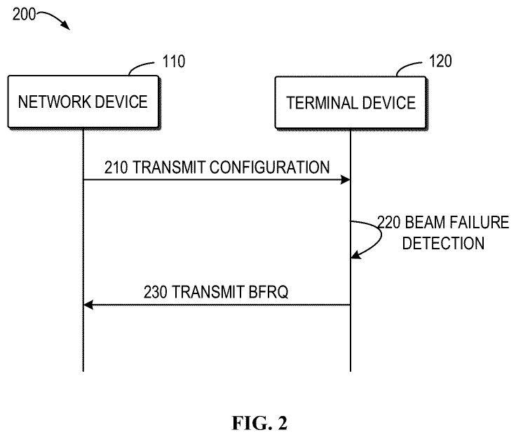

FIG. 2 illustrates a singling chart 200 in accordance with embodiments of the present disclosure. As shown in FIG. 2, the network device 110 may transmit 210 at least one configuration to the terminal device 120. In some embodiments, the at least one configuration may indicate at least one of: a first list of cells, wherein the first list of cells comprises a first cell and a second list of cells; a reference configuration for at least a first spatial reception parameter of the second list of cells referring to the first cell; a TCI state pool configured in a reference cell; and a set of TCI states, wherein the set of TCI states comprises at least one of: a first subset of TCI states, wherein at least one reference signal (RS) in a TCI state of the first subset is associated with a first physical cell identity (ID). For example, the configuration may be transmitted from the network device 110 to the terminal device 120 via at least one of Radio Resource Control (RRC) signaling, Medium Access Control (MAC) control element (CE) or Downlink Control Information (DCI). The terminal device 120 may perform 220 beam failure detection based on the at least one configuration. In response to a beam failure being detected on at least one cell in the group of cells, the terminal device 120 may transmit a BFRQ to the network device 110 based on the at least one configuration. In some embodiments, the BFRQ may comprise cell and/or the first or second list of cells information related to the beam failure detected on the cell or the first or second list of cells.

In some embodiments, the terminal device 120 may be configured with M TRPs in a bandwidth part (BWP) for a cell, where M is a positive integer. For example, 1≤M≤4. For another example, M=2. In some embodiments, each TRP in the M TRPs may be represented by or associated with at least one of the following: a control resource set (CORESET) pool index; a CORESET group identifier (ID); a group of CORESETs; a CORESET set ID; a set of CORESETs; a SRS resource set; a SRS resource set ID; a TCI state; a group of TCI states; an ID of a set of reference signals (RSs) for beam failure detection; an ID of a set of RSs for new/candidate beam identification; spatial relation information; a group of spatial relation information; a set of QCL parameters; a group of RSs for beam failure detection; a group of RSs for new/candidate beam identification; and so on. In the example as shown in FIG. 1B, M=2. In some embodiments, the first TRP 130-1 may be represented by or associated with at least one of the following: a first CORESET pool index (for example, with a value of 0. For another example, CORESET(s) without configuration of the parameter “CORESET pool index”); a first CORESET group/set/subset ID; a first group/set/subset of CORESETs (For example, CORESET(s) configured with the first CORESET pool index or the first CORESET group/set/subset ID. For another example, CORESET(s) not configured with the parameter “CORESET pool index” or the parameter “CORESET group/set/subset ID”); a first SRS resource set; a first SRS resource set ID; a first TCI state; a first group of TCI states; an ID of a first set of reference signals (RSs) for beam failure detection; the first set of reference signals (RSs) for beam failure detection; an ID of a first set of RSs for new/candidate beam identification; the first set of RSs for new/candidate beam identification; first spatial relation information; a first group of spatial relation information; a first set of QCL parameters; a first group of RSs for beam failure detection; a first group of RSs for new/candidate beam identification; and so on. The second TRP 130-2 may be represented by at least one of the following: a second CORESET pool index (for example, with a value of 1); a second CORESET group/set/subset ID; a second group/set/subset of CORESETs (For example, CORESET(s) configured with the second CORESET pool index or the second CORESET group/set/subset ID.); a second SRS resource set; a second SRS resource set ID; a second TCI state; a second group of TCI states; an ID of a second set of reference signals (RSs) for beam failure detection; the second set of reference signals (RSS) for beam failure detection; an ID of a second set of RSs for new/candidate beam identification; the second set of RSs for new/candidate beam identification; second spatial relation information; a second group of spatial relation information; a second set of QCL parameters; a second group of RSs for beam failure detection; a second group of RSs for new/candidate beam identification; and so on.

In some embodiments, the terminal device 120 may be configured with a first TRP (for example, the first TRP 130-1) and a second TRP (for example, the second TRP 130-2) in a BWP for a cell.

In some embodiments, the terminal device 120 may receive a configuration or an activation command, and the configuration or the activation command is used to map up to 8 combinations of one or two TCI states to a set of TCI codepoints. For example, the number of TCI codepoints in the set of TCI may be at least one of {1, 2, 3, 4, 5, 6, 7, 8, 9, 10, 11, 12, 13, 14, 15, 16}. For example, the set of TCI codepoints are indicated in a DCI field “transmission configuration indication”. In some embodiments, if at least one TCI codepoint indicates two TCI states (for example, a first TCI state and a second TCI state), the terminal device 120 may be served with two TRPs (for example, a first TRP and a second TRP). For example, the first TCI state is associated with the first TRP, and the second TCI state is associated with the second TRP.

In the following, the terms “TRP”, “CORESET pool index”, “CORESET group/set/subset ID”, “group/set/subset of CORESETs”, “SRS resource set”, “SRS resource set ID”, “TCI state”, “group of TCI states”, “ID of a set of RSs for beam failure detection”, “ID of a set of RSs for new/candidate beam identification”, “spatial relation information”, “group of spatial relation information”, “set of QCL parameters”, “QCL parameter(s)”, “QCL assumption”, “QCL configuration”, “group of RSs for beam failure detection” and “group of RSs for new/candidate beam identification” can be used interchangeably. The terms “first TRP”, “first CORESET pool index”, “first CORESET group/set/subset ID”, “first group/sct/subset of CORESETs”, “first SRS resource set”, “first SRS resource set ID”, “first TCI state”, “first TCI state of two TCI states corresponding to a TCI codepoint”, “first group of TCI states”, “ID of a first set of RSs for beam failure detection”, “first set of RSs for beam failure detection”, “ID of a first set of RSs for new/candidate beam identification”, “first set of RSs for new/candidate beam identification”, “first spatial relation information”, “first group of spatial relation information”, “first set of QCL parameters”, “first group of RSs for beam failure detection” and “first group of RSs for new/candidate beam identification” can be used interchangeably. The terms “second TRP”, “second CORESET pool index”, “second CORESET group/set/subset ID”, “second group/set/subset of CORESETs”, “second SRS resource set”, “second SRS resource set ID”, “second TCI state”, “second TCI state of two TCI states corresponding to a TCI codepoint”, “second group of TCI states”, “ID of a second set of RSs for beam failure detection”, “second set of RSs for beam failure detection”; “ID of a second set of RSs for new/candidate beam identification”, “second set of RSs for new/candidate beam identification”, “second spatial relation information”, “second group of spatial relation information”, “second set of QCL parameters”, “second group of RSs for beam failure detection” and “second group of RSs for new/candidate beam identification” can be used interchangeably. The terms “PUSCH” and “PUSCH MAC CE” can be used interchangeably. The terms “QCL-TypeD”, “Spatial Rx parameter”, “Spatial receiving parameter” and “Spatial reception parameter” can be used interchangeably.

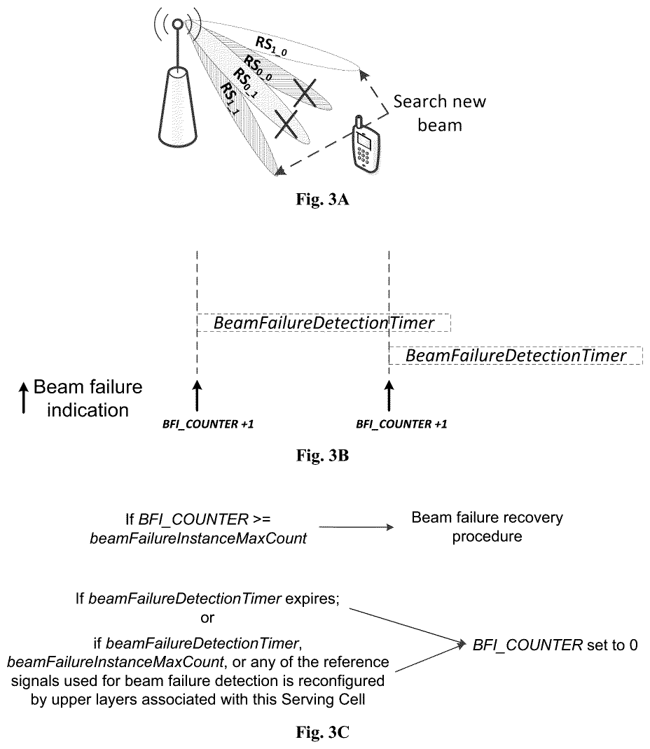

FIGS. 3A-3C illustrate examples in accordance with some embodiments of the present disclosure.

As shown in FIG. 3A, the terminal device 120 may be configured with a set of RSs for beam failure detection (RS_{0_0} and RS_{0_1}), and a set of RSs for new/candidate beam identification (RSI_{1_0} and RS_{1_1}). In case of RS_{0_0} and RS_{0_1} failed, the terminal device may search new beam based on RSI_{1_0} and RSI_{1_1}.

As shown in FIG. 3B, the terminal device 120 may be configured with a timer (BeamFailureDetectionTimer), and if a beam failure instance indication is indicated or received from the lower layers of the terminal device, the value of BFI_COUNTER is increased by 1, and the timer may be started or restarted. For example, if the timer doesn't expire, and if a beam failure instance indication is indicated or received from the lower layers of the terminal device, the value of BFI_COUNTER is increased by 1, and the timer may be started or restarted. For another example, if the timer expires, the value of BFI_COUNTER is set to 0.

As shown in FIG. 3C, if the value of BFI_COUNTER is larger than or equal to a maximum value (beamFailureInstanceMaxCount), the beam failure recovery procedure is triggered. For example, if beamFailureDetection Timer expires or if beamFailureDetection Timer, beamFailureInstanceMaxCount, or any of the RSs used for beam failure detection is reconfigured, the value of BFI_COUNTER is set to 0.

As specified in the 3GPP specifications (TS 38.214), a UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi co-location relationship between one or two downlink reference signals and the DM-RS ports of the PDSCH, the DM-RS port of PDCCH or the channel state information reference signal (CSI-RS) port(s) of a CSI-RS resource. The quasi co-location relationship is configured by the higher layer parameter qcl-Type1 for the first downlink (DL) RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command, as described in clause “TCI States Activation/Deactivation for UE-specific PDSCH MAC CE” (for example, clause 6.1.3.14) of [TS 38.321] or in clause “Enhanced TCI States Activation/Deactivation for UE-specific PDSCH MAC CE” (for example, clause 6.1.3) of [TS 38.321], used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause “TCI States Activation/Deactivation for UE-specific PDSCH MAC CE” or clause “Enhanced TCI States Activation/Deactivation for UE-specific PDSCH MAC CE” (for example, clause 6.1.3.14 or subclause under 6.1.3) of [TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot or the first subslot that is after slot n+3ₛₗₒₜ^{subframe,μ} where is the SCS configuration for the PUCCH. If tci-PresentInDCI is set slot to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the synchronization signal/physical broadcast channel (SS/PBCH) block determined in the initial access procedure with respect to qcl-Type set to ‘typeA’, and when applicable, also with respect to qcl-Type set to ‘typeD’.

In some embodiments, if a UE is configured with the higher layer parameter tci-PresentInDCI that is set as ‘enabled’ or tci-PresentInDCI-ForFormat1_2 is configured for the CORESET scheduling the PDSCH, the UE assumes that the TCI field is present in the DCI (for example DCI format 1_1 or DCI format 1_2) of the PDCCH transmitted on the CORESET. If tci-PresentInDCI or tci-PresentInDCI-ForFormat1_2 is not configured for the CORESET scheduling the PDSCH or the PDSCH is scheduled by a DCI (for example, DCI format 1_0), the UE assumes that the TCI field is not present in the DCI (for example DCI format 1_1 or DCI format 1_2 or DCI format 1_0) of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If tci-PresentInDCI is set to “enabled” or tci-PresentInDCI-ForFormat1_2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to ‘QCL-TypeA’, and when applicable, also with respect to ‘QCL-TypeD’. The value of timeDurationForQCL is based on reported UE capability.

If a UE is configured with the higher layer parameter tci-PresentInDCI that is set as ‘enabled’ for the CORESET scheduling the PDSCH, the UE assumes that the TCI field is present in the DCI (for example, DCI format 1_1) of the PDCCH transmitted on the CORESET. If a UE is configured with the higher layer parameter tci-PresentInDCI-ForFormat1_2 for the CORESET scheduling the PDSCH, the UE assumes that the TCI field with a DCI field size indicated by tci-PresentInDCI-ForFormat1_2 is present in the DCI (for example, DCI format 1_2) of the PDCCH transmitted on the CORESET. If the PDSCH is scheduled by a DCI format not having the TCI field present, and the time offset between the reception of the DL DCI and the corresponding PDSCH is equal to or greater than a threshold timeDurationForQCL if applicable, where the threshold is based on reported UE capability [TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If the PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [TS 38.306]. When the UE is configured with a single slot PDSCH, the indicated TCI state should be based on the activated TCI states in the slot with the scheduled PDSCH. When the UE is configured with a multi-slot PDSCH, the indicated TCI state should be based on the activated TCI states in the first slot or the subslot with the scheduled PDSCH, and UE shall expect the activated TCI states are the same across the slots with the scheduled PDSCH. When the UE is configured with CORESET associated with a search space set for cross-carrier scheduling, and the PDCCH carrying the scheduling DCI and the PDSCH scheduled by that DCI are transmitted on the same carrier, the UE expects tci-PresentInDCI is set as ‘enabled’ or tci-PresentInDCI-ForFormat1_2 is configured for the CORESET, and if one or more of the TCI states configured for the serving cell scheduled by the search space set contains ‘QCL-TypeD’, the UE expects the time offset between the reception of the detected PDCCH in the search space set and the corresponding PDSCH is larger than or equal to the threshold timeDurationForQCL.

Independent of the configuration of tci-PresentInDCI and tci-PresentInDCI-ForFormat1_2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’,
the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
If a UE is configured with enableDefaultTCIStatePerCoresetPoolIndex and the UE is configured by higher layer parameter PDCCH-Config that contains two different values of coresetPoolIndex in different ControlResourceSets,
the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least once symbol and they are associated with same coresetPoolIndex, the UE is expected to prioritize the reception of PDCCH associated with that CORESET. This also applies to the intra-band CA case (when PDSCH and the CORESET are in different component carriers).
If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers)
In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one component carrier, and the PDSCH scheduled by that DCI is on another component carrier and the UE is configured with enableDefaultBeam-ForCCS:
The timeDurationForQCL is determined based on the subcarrier spacing of the scheduled PDSCH. If μ_{PDCCH}<μ_{PDSCH} an additional timing delay d2^{μ}^{_{PDSCH}}/2^{μ}^{_{PDCCH}} is added to the timeDurationForQCL, where d is defined in 5.2.1.5.1a-1, otherwise d is zero;
For both the cases, when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For a periodic CSI-RS resource in an NZP-CSI-RS-ResourceSet configured with higher layer parameter trs-Info, the UE shall expect that a TCI-State indicates one of the following quasi co-location type(s):
‘typeC’ with an SS/PBCH block and, when applicable, ‘typeD’ with the same SS/PBCH block, or
‘typeC’ with an SS/PBCH block and, when applicable, ‘typeD’ with a CSI-RS resource in an NZP-CSI-RS-ResourceSet configured with higher layer parameter repetition, or
For an aperiodic CSI-RS resource in an NZP-CSI-RS-ResourceSet configured with higher layer parameter trs-Info, the UE shall expect that a TCI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with an SS/PBCH block, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeB’ with a CSI-RS resource in a NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeC’ with an SS/PBCH block and, when applicable, ‘typeD’ with the same SS/PBCH block.

For the DM-RS of PDCCH, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

For the DM-RS of PDSCH, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
typeA′ with a CSI-RS resource in a NZP-CSI-RS-ResourceSet configured without higher layer parameter trs-Info and without higher layer parameter repetition and, when applicable, ‘typeD’ with the same CSI-RS resource.

If the PDCCH carrying the scheduling DCI is received on one component carrier, and the PDSCH scheduled by that DCI is on another component carrier: The timeDurationForQCL is determined based on the subcarrier spacing of the scheduled PDSCH. If μPDCCH<μPDSCH an additional timing delay d is added to the timeDurationForQCL, where d is defined as 8 symbols if subcarrier spacing for the PDCCH is 15 kHz, or 8 symbols if subcarrier spacing for the PDCCH is 30 kHz, or 14 symbols if subcarrier spacing for the PDCCH is 60 kHz. For example, the symbol is PDCCH symbol, or the symbol is based on the subcarrier spacing of PDCCH (for example, as defined in Table 5.2.1.5.1a-1 of TS 38.214); For both the cases when tci-PresentInDCI is set to ‘enabled’ and the offset between the reception of the DL DCI and the corresponding PDSCH is less than the threshold timeDurationForQCL and when tci-PresentInDCI is not configured, the UE obtains its QCL assumption for the scheduled PDSCH from the activated TCI state with the lowest ID applicable to PDSCH in the active BWP of the scheduled cell.

As specified in the 3GPP specifications (TS 38.214), when a UE is configured by higher layer parameter RepSchemeEnabler set to one of ‘FDMSchemeA’, ‘FDMSchemeB’, ‘TDMSchemeA’, if the UE is indicated with two TCI states in a codepoint of the DCI field ‘Transmission Configuration Indication’ and DM-RS port(s) within one CDM (Code Domain Multiplexing) group in the DCI field “Antenna Port(s)”. When two TCI states are indicated in a DCI and the UE is set to ‘FDMSchemeA’, the UE shall receive a single PDSCH transmission occasion of the TB with each TCI state associated to a non-overlapping frequency domain resource allocation as described in clause “Physical resource block (PRB) bundling” (for example Clause 5.1.2.3) in TS 38.214. When two TCI states are indicated in a DCI and the UE is set to ‘FDMSchemeB’, the UE shall receive two PDSCH transmission occasions of the same TB with each TCI state associated to a PDSCH transmission occasion which has non-overlapping frequency domain resource allocation with respect to the other PDSCH transmission occasion as described in clause “Physical resource block (PRB) bundling” (for example Clause 5.1.2.3) in TS 38.214. When two TCI states are indicated in a DCI and the UE is set to ‘TDMSchemeA’, the UE shall receive two PDSCH transmission occasions of the same TB with each TCI state associated to a PDSCH transmission occasion which has non-overlapping time domain resource allocation with respect to the other PDSCH transmission occasion and both PDSCH transmission occasions shall be received within a given slot as described in Clause “Resource allocation in time domain” (for example, clause 5.1.2.1) in TS 38.214.

When a UE is configured by the higher layer parameter PDSCH-config that indicates at least one entry in pdsch-TimeDomainAllocationList containing RepNumR16 in PDSCH-TimeDomainResourceAllocation, the UE may expect to be indicated with one or two TCI states in a codepoint of the DCI field ‘Transmission Configuration Indication’ together with the DCI field “Time domain resource assignment’ indicating an entry in pdsch-TimeDomainAllocationList which contain RepNum16 in PDSCH-TimeDomainResourceAllocation and DM-RS port(s) within one CDM group in the DCI field “Antenna Port(s)”. When two TCI states are indicated in a DCI with ‘Transmission Configuration Indication’ field, the UE may expect to receive multiple slot level PDSCH transmission occasions of the same TB with two TCI states used across multiple PDSCH transmission occasions as defined in Clause “Resource allocation in time domain” (for example, clause 5.1.2.1) in TS 38.214. When one TCI state is indicated in a DCI with ‘Transmission Configuration Indication’ field, the UE may expect to receive multiple slot level PDSCH transmission occasions of the same TB with one TCI state used across multiple PDSCH transmission occasions as defined in Clause “Resource allocation in time domain” (for example, clause 5.1.2.1) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with two TCI states in a codepoint of the DCI field ‘Transmission Configuration Indication’ and DM-RS port(s) within two CDM groups in the DCI field “Antenna Port(s)”, the UE may expect to receive a single PDSCH where the association between the DM-RS ports and the TCI states are as defined in Clause “DM-RS reception procedure” (for example, clause 5.1.6.2) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with one TCI states in a codepoint of the DCI field ‘Transmission Configuration Indication’, the UE procedure for receiving the PDSCH upon detection of a PDCCH follows Clause “UE procedure for receiving the physical downlink shared channel” (for example, Clause 5.1) in TS 38.214.

In the following, the terms “FDMSchemeA” and “Scheme 2a” can be used interchangeably. The terms “FDMSchemeB” and “Scheme 2b” can be used interchangeably. The terms “TDMSchemeA” and “Scheme 3” can be used interchangeably. The terms “RepNumR16” and “Scheme 4” can be used interchangeably.

As specified in the 3GPP specifications (TS 38.214), when a UE is configured by the higher layer parameter RepSchemeEnabler set to ‘TDMSchemeA’ and indicated DM-RS port(s) within one CDM group in the DCI field “Antenna Port(s)”, the number of PDSCH transmission occasions is derived by the number of TCI states indicated by the DCI field ‘Transmission Configuration Indication’ of the scheduling DCI. If two TCI states are indicated by the DCI field ‘Transmission Configuration Indication’, the UE is expected to receive two PDSCH transmission occasions, where the first TCI state is applied to the first PDSCH transmission occasion and resource allocation in time domain for the first PDSCH transmission occasion follows Clause “Resource allocation in time domain” (for example, clause 5.1.2.1) in TS 38.214. The second TCI state is applied to the second PDSCH transmission occasion, and the second PDSCH transmission occasion shall have the same number of symbols as the first PDSCH transmission occasion. If the UE is configured by the higher layers with a value K in StartingSymbolOffsetK, it shall determine that the first symbol of the second PDSCH transmission occasion starts after K symbols from the last symbol of the first PDSCH transmission occasion. If the value K is not configured via the higher layer parameter StartingSymbolOffsetK, K=0 shall be assumed by the UE. The UE is not expected to receive more than two PDSCH transmission layers for each PDSCH transmission occasion. For two PDSCH transmission occasions, the redundancy version to be applied is derived according to Table 5.1.2.1-2 in TS 38.214, where n=0, 1 applied respectively to the first and second TCI state. Otherwise, the UE is expected to receive a single PDSCH transmission occasion, and the resource allocation in the time domain follows Clause “Resource allocation in time domain” (for example, clause 5.1.2.1) in TS 38.214.

As specified in the 3GPP specifications (TS 38.214), when a UE configured by the higher layer parameter PDSCH-config that indicates at least one entry in pdsch-TimeDomainAllocationList contain RepNumR16 in PDSCH-TimeDomainResourceAllocation. If two TCI states are indicated by the DCI field ‘Transmission Configuration Indication’ together with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV (Start and length indicator value) is applied for all PDSCH transmission occasions, the first TCI state is applied to the first PDSCH transmission occasion and resource allocation in time domain for the first PDSCH transmission occasion follows Clause “Resource allocation in time domain” (for example, clause 5.1.2.1) in TS 38.214. When the value indicated by RepNumR16 in PDSCH-TimeDomainResourceAllocation equals to two, the second TCI state is applied to the second PDSCH transmission occasion. When the value indicated by RepNumR16 in PDSCH-TimeDomainResourceAllocation is larger than two, the UE may be further configured to enable CycMapping or SeqMapping in RepTCIMapping. When CycMapping is enabled, the first and second TCI states are applied to the first and second PDSCH transmission occasions, respectively, and the same TCI mapping pattern continues to the remaining PDSCH transmission occasions. When SeqMapping is enabled, first TCI state is applied to the first and second PDSCH transmissions, and the second TCI state is applied to the third and fourth PDSCH transmissions, and the same TCI mapping pattern continues to the remaining PDSCH transmission occasions. The UE may expect that each PDSCH transmission occasion is limited to two transmission layers. For all PDSCH transmission occasions associated with the first TCI state, the redundancy version to be applied is derived according to Table 5.1.2.1-2 [TS 38.214], where n is counted only considering PDSCH transmission occasions associated with the first TCI state. The redundancy version for PDSCH transmission occasions associated with the second TCI state is derived according to Table 5.1.2.1-3 [TS 38.214], where additional shifting operation for each redundancy version rvs is configured by higher layer parameter RVSeqOffset and n is counted only considering PDSCH transmission occasions associated with the second TCI state. If one TCI state is indicated by the DCI field ‘Transmission Configuration Indication’ together with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV is applied for all PDSCH transmission occasions, the first PDSCH transmission occasion follows Clause “Resource allocation in time domain” (for example, clause 5.1.2.1) in TS 38.214, the same TCI state is applied to all PDSCH transmission occasions. The UE may expect that each PDSCH transmission occasion is limited to two transmission layers. For all PDSCH transmission occasions, the redundancy version to be applied is derived according to Table 5.1.2.1-2 [TS 38.214], where n is counted considering PDSCH transmission occasions. Otherwise, the UE is expected to receive a single PDSCH transmission occasion, and the resource allocation in the time domain follows Clause “Resource allocation in time domain” (for example, clause 5.1.2.1) in TS 38.214.

TABLE 5.1.2.1-2
Applied redundancy version when pdsch-AggregationFactor is present

| rv_{id} indicated by the DCI | rv_{id} to be applied to n^{th} transmission occasion | | | |
|---|---|---|---|---|
| scheduling the PDSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 5.1.2.1-3
Applied redundancy version for the second TCI state when RVSeqOffset is present

| rv_{id} indicated by the DCI | rv_{id} to be applied to n^{th} transmission occasion with second TCI state | | | |
|---|---|---|---|---|
| scheduling the PDSCH | n mod 4 = 0 | n mod 4 = 1 | n mod 4 = 2 | n mod 4 = 3 |
| 0 | (0 + rvₛ) mod 4 | (2 + rvₛ) mod 4 | (3 + rvₛ) mod 4 | (1 + rvₛ) mod 4 |
| 2 | (2 + rvₛ) mod 4 | (3 + rvₛ) mod 4 | (1 + rvₛ) mod 4 | (0 + rvₛ) mod 4 |
| 3 | (3 + rvₛ) mod 4 | (1 + rvₛ) mod 4 | (0 + rvₛ) mod 4 | (2 + rvₛ) mod 4 |
| 1 | (1 + rvₛ) mod 4 | (0 + rvₛ) mod 4 | (2 + rvₛ) mod 4 | (3 + rvₛ) mod 4 |

As specified in the 3GPP specifications (TS 38.214), For a UE configured by the higher layer parameter RepSchemeEnabler set to ‘FDMSchemeA’ or ‘FDMSchemeB’, and when the UE is indicated with two TCI states in a codepoint of the DCI field ‘Transmission Configuration Indication and DM-RS port(s) within one CDM group in the DCI field “Antenna Port(s)”. If P_{BWP,i}′ is determined as “wideband”, the first

$$⌈ \frac{{n}_{PRB}}{2} ⌉$$

PRBs are assigned to the first TCI state and the remaining

$$⌊ \frac{{n}_{PRB}}{2} ⌋$$

PRBs are assigned to the second TCI state, where n_{PRB} is the total number of allocated PRBs for the UE. If P_{BWP,i}′ is determined as one of the values among {2, 4}, even PRGs within the allocated frequency domain resources are assigned to the first TCI state and odd PRGs within the allocated frequency domain resources are assigned to the second TCI state. The UE is not expected to receive more than two PDSCH transmission layers for each PDSCH transmission occasion.

For a UE configured by the higher layer parameter RepSchemeEnabler set to ‘FDMSchemeB’, and when the UE is indicated with two TCI states in a codepoint of the DCI field ‘Transmission Configuration Indication and DM-RS port(s) within one CDM group in the DCI field “Antenna Port(s)”, each PDSCH transmission occasion shall follow the Clause “Physical downlink shared channel” (for example Clause 7.3.1) of [TS 38.211] with the mapping to resource elements determined by the assigned PRBs for corresponding TCI state of the PDSCH transmission occasion, and the UE shall only expect at most two code blocks per PDSCH transmission occasion when a single transmission layer is scheduled and a single code block per PDSCH transmission occasion when two transmission layers are scheduled. For two PDSCH transmission occasions, the redundancy version to be applied is derived according to Table 5.1.2.1-2 of [TS 38.214], where n=0, 1 are applied to the first and second TCI state, respectively.

As specified in the 3GPP specifications (TS 38.213), for a CORESET other than a CORESET with index 0,
if a UE has not been provided a configuration of TCI state(s) by tci-StatesPDCCH-ToAddList and tci-StatesPDCCH-ToReleaseList for the CORESET, or has been provided initial configuration of more than one TCI states for the CORESET by tci-StatesPDCCH-ToAddList and tci-StatesPDCCH-ToReleaseList but has not received a MAC CE activation command for one of the TCI states, the UE assumes that the DM-RS antenna port associated with PDCCH receptions is quasi co-located with the SS/PBCH block the UE identified during the initial access procedure;
if a UE has been provided a configuration of more than one TCI states by tci-StatesPDCCH-ToAddList and tci-StatesPDCCH-ToReleaseList for the CORESET as part of Reconfiguration with sync procedure but has not received a MAC CE activation command for one of the TCI states, the UE assumes that the DM-RS antenna port associated with PDCCH receptions is quasi co-located with the SS/PBCH block or the CSI-RS resource the UE identified during the random access procedure initiated by the Reconfiguration with sync procedure.

In some embodiments, for a CORESET with index 0, the UE assumes that a DM-RS antenna port for PDCCH receptions in the CORESET is quasi co-located with
the one or more DL RS configured by a TCI state, where the TCI state is indicated by a MAC CE activation command for the CORESET, if any, or
a SS/PBCH block the UE identified during a most recent random access procedure not initiated by a PDCCH order that triggers a contention-free random access procedure, if no MAC CE activation command indicating a TCI state for the CORESET is received after the most recent random access procedure.

In some embodiments, for a CORESET other than a CORESET with index 0, if a UE is provided a single TCI state for a CORESET, or if the UE receives a MAC CE activation command for one of the provided TCI states for a CORESET, the UE assumes that the DM-RS antenna port associated with PDCCH receptions in the CORESET is quasi co-located with the one or more DL RS configured by the TCI state. For a CORESET with index 0, the UE expects that a CSI-RS configured with qcl-Type set to ‘typeD’ in a TCI state indicated by a MAC CE activation command for the CORESET is provided by a SS/PBCH block, and if the UE receives a MAC CE activation command for one of the TCI states, the UE applies the activation command in the first slot that is after slot k+3Nₛₗₒₜ^{subframe,μ} where k is the slot where the UE would transmit a PUCCH with HARQ-ACK information for the PDSCH providing the activation command and u is the SCS configuration for the PUCCH. The active BWP is defined as the active BWP in the slot when the activation command is applied.

In some embodiments, if a UE is configured for single cell operation or for operation with carrier aggregation in a same frequency band, and monitors PDCCH candidates in overlapping PDCCH monitoring occasions in multiple CORESETs that have been configured with same or different qcl-Type set to ‘typeD’ properties on active DL BWP(s) of one or more cells, then the UE monitors PDCCHs only in a CORESET, and in any other CORESET from the multiple CORESETs that have been configured with qcl-Type set to same ‘typeD’ properties as the CORESET, on the active DL BWP of a cell from the one or more cells
the CORESET corresponds to the CSS set with the lowest index in the cell with the lowest index containing CSS, if any; otherwise, to the USS set with the lowest index in the cell with lowest index
the lowest USS set index is determined over all USS sets with at least one PDCCH candidate in overlapping PDCCH monitoring occasions
for the purpose of determining the CORESET, a SS/PBCH block is considered to have different QCL ‘typeD’ properties than a CSI-RS
for the purpose of determining the CORESET, a first CSI-RS associated with a SS/PBCH block in a first cell and a second CSI-RS in a second cell that is also associated with the SS/PBCH block are assumed to have same QCL ‘typeD’ properties
the allocation of non-overlapping CCEs and of PDCCH candidates for PDCCH monitoring is according to all search space sets associated with the multiple CORESETs on the active DL BWP(s) of the one or more cells
the number of active TCI states is determined from the multiple CORESETs.

In some embodiments, if a UE is configured for single cell operation or for operation with carrier aggregation in a same frequency band, and monitors PDCCH candidates in overlapping PDCCH monitoring occasions in multiple CORESETs where none of the CORESETs has TCI-states configured with qcl-Type set to ‘typeD’, then the UE is required to monitor PDCCH candidates in overlapping PDCCH monitoring occasions for search space sets associated with different CORESETs.

In some embodiments, there is an application timing for beam indication or TCI state(s) indication. In some embodiments, the application timing may be the first slot or first subslot that is at least X ms or Y symbols after the last symbol of the acknowledge of the joint or separate DL/UL beam indication. For example, Y may be integer, and 1<=Y<=336. In some embodiments, slot may include 12 or 14 symbols. In some embodiments, subslot may include S symbols. S is integer, and 1<=S<=14. For example, S may be at least one of {2, 4, 7}. In some embodiments, the beam indication is indicated in a DCI in a PDCCH. For example, the DCI in the PDCCH may schedule a PDSCH or may not schedule a PDSCH. In some embodiments, the gap between the last symbol of the DCI and the first slot or the first subslot shall satisfy the capability for the terminal device. In some embodiments, the acknowledge of the joint or separate DL/UL beam indication may be the acknowledge of the PDSCH scheduled by the DCI. For example, when the DCI schedules the PDSCH. In some embodiments, the acknowledge of the joint or separate DL/UL beam indication may be the acknowledge of the DCI. For example, when the DCI doesn't schedule a PDSCH.

In some embodiments, the terminal device may receive or detect a DCI (for example, represented as “DCI_t”) in a PDCCH, and the DCI indicates a joint DL/UL TCI state or a separate DL/UL TCI state or a DL TCI state or a UL TCI state or a pair of DL/UL TCI states. In some embodiments, a first time threshold may indicate a predetermined/configured time period after the first or last symbol of the PDCCH or the first or last symbol of the acknowledge of the indication. In some embodiments, the indicated joint DL/UL TCI state or separate DL/UL TCI state or DL TCI state or UL TCI state or the pair of DL/UL TCI states may be applied to PDSCH and/or CORESET and/or PUSCH and/or PUCCH and/or uplink RS and/or downlink RS after the application timing or the first time threshold. For example, when a joint DL/UL TCI state is indicated in the DCI, the joint DL/UL TCI state may be applied to PDSCH and/or CORESET and/or PUSCH and/or PUCCH and/or uplink RS and/or downlink RS after the application timing or the first time threshold. For another example, when a DL TCI state is indicated in the DCI, the DL TCI state may be applied to PDSCH and/or CORESET and/or downlink RS after the application timing or the first time threshold. For another example, when an UL TCI state is indicated in the DCI, the UL TCI state may be applied to PUSCH and/or PUCCH and/or uplink RS after the application timing or the first time threshold. For another example, when a pair of DL/UL TCI states are indicated in the DCI, the DL TCI state may be applied to PDSCH and/or CORESET and/or downlink RS after the application timing or the first time threshold, and the UL TCI state may be applied to PUSCH and/or PUCCH and/or uplink RS after the application timing or the first time threshold.

In some embodiments, the terminal device 120 may receive an indication to indicate a downlink TCI state (or a beam or a set of QCL parameters), and the source reference signal(s) in the TCI state provides QCL information at least for reception on PDSCH and all of CORESETs in a component carrier (CC). For example, the PDSCH is dedicated or UE-specific.

In some embodiments, the terminal device 120 may receive an indication to indicate an uplink TCI state (or a beam or a spatial relation), and the source reference signal(s) in the TCI state provides a reference for determining uplink transmission spatial filter at least for dynamic grant or configured grant based PUSCH, and all of PUCCH resources in a CC. For example, the PUCCH is dedicated or UE-specific.

In some embodiments, the terminal device 120 may receive an indication to indicate a joint TCI state (or a beam or a set of QCL parameters), and the TCI state refers to at least a common source reference signal used for determining both the downlink QCL information and the uplink transmission spatial filter.

In some embodiments, the terminal device 120 may receive an indication to indicate a downlink TCI state (or a beam or a set of QCL parameters) and an uplink TCI state (or a beam or a spatial relation), and the source reference signal(s) in the DL TCI state provides QCL information at least for reception on PDSCH and all of CORESETs in a component carrier (CC), and the source reference signal(s) in the TCI state provides a reference for determining uplink transmission spatial filter at least for dynamic grant or configured grant based PUSCH, and all of PUCCH resources in a CC. For example, the PUCCH is dedicated or UE-specific. For another example, the PDSCH is dedicated or UE-specific.

In some embodiments, the terminal device 120 may be configured with more than one (For example, represented as M, M is positive integer. For example, M may be 2 or 3 or 4) downlink TCI states, and/or the terminal device 120 may receive an indication to indicate one of the M TCI states, and the source reference signal(s) in the one of the M TCI states or in the indicated one TCI state provides QCL information at least for reception on PDSCH and/or a subset of CORESETs in a CC. For example, the PDSCH is dedicated or UE-specific.

In some embodiments, the terminal device 120 may be configured with more than one (For example, represented as N, N is positive integer. For example, N may be 2 or 3 or 4) uplink TCI states, and/or the terminal device 120 may receive an indication to indicate one of the N TCI states, and the source reference signal(s) in the one of the N TCI states or in the indicated one TCI state provides a reference for determining uplink transmission spatial filter at least for dynamic grant or configured grant based PUSCH, and/or a subset of PUCCH resources in a CC. For example, the PUCCH is dedicated or UE-specific.

In some embodiments, the terminal device 120 may be configured with more than one (For example, represented as M, M is positive integer. For example, M may be 2 or 3 or 4) joint DL/UL TCI states, and/or receive an indication to indicate one from the M joint TCI states, and each one of the M TCI states or the indicated one TCI state refers to at least a common source reference signal used for determining both the downlink QCL information and the uplink transmission spatial filter.

In some embodiments, synchronization signal/physical broadcast channel (SS/PBCH) block may be represented as SSB in this disclosure.

In some embodiments, the terminal device 120 may be configured with more than one (For example, represented as M, M is positive integer. For example, M may be 2 or 3 or 4) downlink TCI states and the terminal device 120 may be configured with more than one (For example, represented as N, N is positive integer. For example, N may be 2 or 3 or 4) uplink TCI states, and/or the terminal device 120 may receive an indication to indicate one from the M downlink TCI states and one from the N uplink TCI states, and the source reference signal(s) in each one of the M DL TCI states or the indicated one DL TCI state provides QCL information at least for reception on PDSCH and/or a subset of CORESETs in a component carrier (CC), and the source reference signal(s) in each one of the N TCI states or in the indicated one UL TCI state provides a reference for determining uplink transmission spatial filter at least for dynamic grant or configured grant based PUSCH, and/or a subset of PUCCH resources in a CC. For example, the PUCCH is dedicated or UE-specific. For another example, the PDSCH is dedicated or UE-specific.

In the following, DCI_t may be used to describe the DCI for joint DL/UL TCI state indication or for separate DL/UL TCI state indication. In the following, the terms “DCI”, “PDCCH”, “DCI_t”, “DCI for joint DL/UL TCI state indication”, “DCI for separate DL/UL TCI state indication”, “DCI for DL TCI state indication”, “DCI for UL TCI state indication”, “PDCCH for joint DL/UL TCI state indication”, “PDCCH for separate DL/UL TCI state indication”, “PDCCH for DL TCI state indication”, “PDCCH for UL TCI state indication”, “DCI for TCI state indication” and “PDCCH for TCI state indication” can be used interchangeably.

In some embodiments, a DCI may be used for indicating a TCI state for joint DL/UL TCI state indication or for separate DL/UL TCI state indication. And the DCI may schedule a PDSCH (for example, DCI format 1_1 and format 1_2). In some embodiments, the HARQ of the PDSCH scheduled by the DCI can be used as an ACK for the DCI. For example, the DCI may be DCI_t.

In some embodiments, a DCI may be used for indicating a TCI state for joint DL/UL TCI state indication or for separate DL/UL TCI state indication. And the DCI may not schedule a PDSCH (for example, DCI format 1_1 and format 1_2). In some embodiments, a HARQ of the DCI may be introduced to indicate whether the DCI or the TCI state indication is successful. For example, the DCI may be DCI_t.

In some embodiments, if decoding of DCI_t or decoding of the PDSCH scheduled by DCI_t is ACK, the indicated TCI state may be applied for PDSCH and/or all or subset of CORESETs after the application timing.

In some embodiments, a DCI (for example, DCI_t) may be used for indicating one or more TCI states. For example, the one or more TCI states are for joint DL/UL TCI state indication or for separate DL/UL TCI state indication. And the DCI may not schedule a PDSCH (for example, DCI format 1_1 and format 1_2). In some embodiments, upon a successful reception/decoding of the DCI, the terminal device 120 may report an ACK. In some embodiments, upon a failed reception/decoding of the DCI, the terminal device 120 may report a NACK. For example, the ACK and/or NACK may be reported in a physical uplink control channel (PUCCH) or a physical uplink shared channel (PUSCH). In some embodiments, the terminal device 120 may be configured with a type of HARQ codebook. For example, the type may be at least one of Type 1 (for example, semi-static), Type 2 (for example, dynamic) and Type 3 (one shot feedback). For example, the type may be configured via at least one of RRC, MAC CE and DCI. In some embodiments, the DCI is received/detected in a PDCCH.

In some embodiments, the terminal device 120 may be configured/indicated with a first TCI state for reception of PDSCH and/or all or a subset of CORESETs. And the terminal device 120 may receive or detect a PDCCH with the first TCI state, and the PDCCH is in a first CORESET. In some embodiments, the terminal device 120 may be indicated with a second TCI state in the DCI received or detected in the first PDCCH. In some embodiments, the DCI in the PDCCH may schedule or may not schedule a first PDSCH or a first PUSCH. In some embodiments, the terminal device 120 may report the decoding result or HARQ-ACK information for at least one of the DCI or the PDCCH or the first PDSCH to the network device 110. For example, the decoding result or the HARQ-ACK information may be transmitted/reported in a PUCCH or in a second PUSCH. In some embodiments, after the application timing or after the first time threshold, the terminal device 120 may receive PDSCH and/or all or the subset of CORESETs with the second TCI state. For example, the terminal device 120 may receive another PDCCH with the second TCI state, and the another PDCCH is in a second CORESET. For another example, the terminal device 120 may receive another PDCCH with the second TCI state, and the another PDCCH is in the first CORESET.

In some embodiments, the terminal device 120 may receive an indication of a first TCI state, wherein the one or two RSs in the first TCI state may be associated with a first physical cell identity (ID). In some embodiments, the terminal device 120 may monitor or receive a first PDCCH in a first monitoring occasion for a first search space and/or associated scheduling or PDSCH scheduled by the first PDCCH based on a second TCI state or based on a quasi co-location (QCL) assumption, wherein the one or two RSs in the second TCI state and/or the QCL assumption may be associated with a second physical cell ID. In some embodiments, the terminal device 120 may monitor or receive a second PDCCH in a second monitoring occasion for a second search space and/or associated scheduling scheduled by the second PDCCH based on a condition.

In some embodiments, the scheduling may be at least one of: PDSCH, PUSCH, PUCCH, HARQ feedback, CSI-RS, SRS, downlink DM-RS, uplink DM-RS, downlink PTRS, uplink PTRS and TRS.

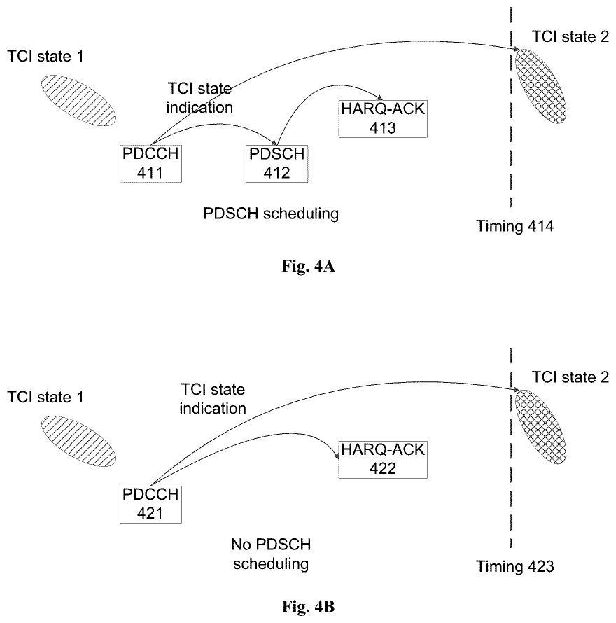

FIGS. 4A-4B illustrate examples in accordance with some embodiments of the present disclosure.

As shown in FIG. 4A, the terminal device 120 may be configured/indicated with TCI state 1. For example, the TCI state 1 is applied for reception of PDSCH and/or all or a subset of CORESETs. And the terminal device 120 may receive or detect a PDCCH 411 with the TCI state 1. And the PDCCH 411 or the DCI detected in the PDCCH 411 may indicate TCI state 2. And the PDCCH 411 or the DCI detected in the PDCCH 411 may schedule a PDSCH 412. And the terminal device 120 may report HARQ-ACK 413 for the PDSCH 412 to the network device 110. And after the application timing 414, the terminal device 120 may receive PDSCH and/or all or the subset of CORESETs with the TCI state 2. For example, the application timing 414 may be based on the first threshold and at least one of the first or last symbol of PDCCH 411 and the first or last symbol of the PUCCH or PUSCH for reporting HARQ-ACK 413. For example, the HARQ-ACK information may be acknowledge.

As shown in FIG. 4B, the terminal device 120 may be configured/indicated with TCI state 1. For example, the TCI state 1 is applied for reception of PDSCH and/or all or a subset of CORESETs. And the terminal device 120 may receive or detect a PDCCH 421 with the TCI state 1. And the PDCCH 421 or the DCI detected in the PDCCH 421 may indicate TCI state 2. For example, the PDCCH 421 or the DCI detected in the PDCCH 421 may not schedule PDSCH. And the terminal device 120 may report HARQ-ACK 422 for the PDCCH 421 to the network device 110. And after the application timing 423, the terminal device 120 may receive PDSCH and/or all or the subset of CORESETs with the TCI state 2. For example, the application timing 423 may be based on the first threshold and at least one of the first or last symbol of PDCCH 421 and the first or last symbol of the PUCCH or PUSCH for reporting HARQ-ACK 422. For example, the HARQ-ACK information may be acknowledge.

In some embodiments, the terminal device 120 may be configured with a first list of cells, and the first list of cells may comprise a first cell and a second list of cells. For example, there may be C cells in the second list of cells, C is a positive integer. For example, 1<=C<=32.

In some embodiments, at least one TCI state on at least one cell in the second list may refer to the first cell. In some embodiments, the first cell may be a reference cell for the second list of cells. In some embodiments, there may be at least one TCI state configured on the first cell, and a TCI state on at least one cell in the second list may refer to one of the at least one TCI state configured on the first cell. In some embodiments, there may be a list of TCI states configured on at least one cell in the second list, and a TCI state on the at least one cell (For example, the TCI state is configured with a value of identity (ID) with ID_1.) may refer or correspond to a TCI state on the first cell (For example, the TCI state is configured with a same value of ID with ID_1 on the first cell). In some embodiments, the at least one cell in the second list may be represented as a second cell in this disclosure.

In some embodiments, at least for source RS and/or quasi co-location (QCL) information (info) configured with qcl-Type to be qcl-TypeA, the RS configured on the second cell is applied for source RS. For example, the index of the RS associated with TCI state on the second cell may be same or different from the index of the RS associated with TCI state on the first cell. The example may be shown in Table 1. For example, cell index and/or BWP ID associated with the TCI state on the second cell may be absent. For another example, cell index and/or BWP ID associated with the TCI state on the second cell may be configured, and the value may be ignored.

TABLE 1
Source RS and QCL info configuration

| Source RS and QCL info = | | |
|---|---|---|
| cell | configured as | “absent” |
| BWP-ID | configured as | “absent” |
| qcl-Type | configured as | TypeA, |

In some embodiments, the ID configured for a TCI state may be non-negative integer. For example, 0<=ID<=191. In some embodiments, ID_1, ID_2 . . . and ID_n are non-negative integers. For example, 0<=ID_1<=191. For example, 0<=ID_2<=191. For example, 0<=ID_n<=191.

In some embodiments, for source RS and/or QCL info configured with qcl-Type to be qcl-TypeD, wherein the source RS and/or QCL info is associated with the TCI state on the second cell, if the cell index is configured as the index of the first cell, the RS configured on the first cell is applied for source RS. An example may be shown in Table 2.

TABLE 2
Source RS and QCL info configuration

| Source RS and QCL info = | | |
|---|---|---|
| cell | configured as | index of the first cell |
| qcl-Type | configured as | TypeD, |

In some embodiments, for source RS and/or QCL info configured with qcl-Type to be qcl-TypeD, wherein the source RS and/or QCL info is associated with the TCI state on the second cell, if the cell index is configured as the index of the first cell, and if the BWP-ID is configured with a value “bwp_id1” or configured with “absent”, the RS configured on the active BWP on the first cell is applied for source RS. In some embodiments, bwp_id1 is a non-negative value. For example, bwp_id1 may be at least one of {0, 1, 2, 3, 4}. For example, the value configured for BWP-ID is ignored. In some embodiments, for source RS and/or QCL info configured with qcl-Type to be qcl-TypeD, wherein the source RS and/or QCL info is associated with the TCI state on the second cell, if the cell index is configured as the index of the first cell, and if the BWP-ID is configured with a value “bwp_id1”, the RS configured on the BWP configured with same value “bwp_id1” on the first cell is applied for source RS. In some embodiments, for source RS and/or QCL info configured with qcl-Type to be qcl-TypeD, wherein the source RS and/or QCL info is associated with the TCI state on the second cell, if the cell index is configured as the index of the first cell, then BWP-ID is not expected to be configured with “absent”.

In some embodiments, for source RS and/or QCL info configured with qcl-Type to be qcl-TypeD, wherein the source RS and/or QCL info is associated with the TCI state on the second cell, if the cell index is configured as the index of the first cell, the RS configured on the first cell is applied for source RS. In some embodiments, there may be a TCI state configured with TCI state ID_1 on the first cell, and there may be a TCI state configured with TCI state ID_1 on the second cell. In some embodiments, there may be a first RS configured in the TCI state ID_1 on the first cell, and the first RS is configured with ID1_1. In some embodiments, there may be a second RS configured in the TCI state ID_1 on the second cell, and the second RS is configured with ID2_1. In some embodiments, if the TCI state ID_1 is indicated/activated/applied for the first list of cells and/or the first cell and/or the second cell, on the second cell, the first RS on the first cell may be applied for source RS for qcl-TypeD. In some embodiments, if the TCI state ID_1 is indicated/activated/applied for the first list of cells and/or the first cell and/or the second cell, on the second cell, a third RS on the first cell may be applied for source RS for qcl-TypeD. For example, the third RS is an RS configured with ID2_1 on the first cell. In some embodiments, the value of ID2_1 may be ignored. In some embodiments, the value of ID2_1 may be assumed to be same with ID1_1.

In some embodiments, there may be a list of TCI states configured on second cell, the terminal device 120 may expect or assume presence and/or values of cell and/or values of BWP-ID configured in the list of TCI states are same.

In some embodiments, the terminal device 120 may be configured with a common configuration for reference on the second cell. For example, the common configuration may be applied to a list of TCI states configured/indicated/activated for the first cell and/or the second cell. For example, the list of TCI states may be Rel-17 TCI state pool configured on the first cell. In some embodiments, there may be index of cell and/or BWP-ID configured in the common configuration.

In some embodiments, at least for source RS and/or QCL info configured with qcl-Type to be qcl-TypeA, the RS configured on the second cell is applied for source RS. For example, there may be no configuration of the index of the RS associated with TCI state on the second cell. In some embodiments, there may be a TCI state configured with TCI state ID_1 on the first cell. For example, there may be no TCI state (configured with TCI state ID_1) configuration on the second cell. In some embodiments, there may be a first RS configured in the TCI state ID_1 on the first cell, and the index of the RS associated with TCI state ID_1 on the first cell may be configured with ID1_1. In some embodiments, if the TCI state ID_1 is indicated/activated and applied for the first cell and/or the second cell, an RS with same value of ID1_1 configured on the second cell may be applied for source RS. For example, for qcl-TypeA for the second cell.

In some embodiments, for source RS and/or QCL info configured with qcl-Type to be qcl-TypeD, the RS configured on the first cell is applied for source RS. In some embodiments, there may be a TCI state configured with TCI state ID_1 on the first cell. For example, there may be no TCI state (configured with TCI state ID_1) configuration on the second cell. In some embodiments, there may be a first RS configured in the TCI state ID_1 on the first cell, and the index of the RS associated with TCI state ID_1 on the first cell may be configured with ID1_1. In some embodiments, if the TCI state ID_1 is indicated/activated and applied for the first cell and/or the second cell, an RS with same value of ID1_1 configured on the first cell may be applied for source RS. For example, for qcl-TypeD for the second cell.

In some embodiments, the terminal device 120 may be configured with a first list of TCI states (e.g. Rel-17 TCI states) and a second list of TCI states (e.g. Rel-15/16 TCI states) on the first cell. In some embodiments, if a TCI state in the first list is indicated/activated, the TCI state may be applied to the first cell and the second cell after the application timing. In some embodiments, if a TCI state in the second list is indicated/activated, the TCI state may be applied to the first cell (For example, the TCI state may be applied to non-UE dedicated and/or UE dedicated channel and/or RS on the first cell). For example, after the application timing. For example, the TCI state may not be applied to the second cell. In some embodiments, the previous or latest indicated/activated/applied TCI state which is included in the first list may be applied to the second cell.

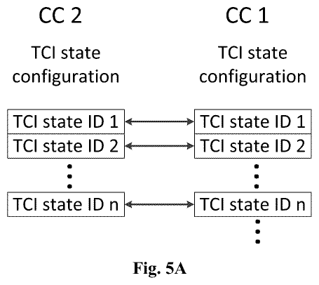

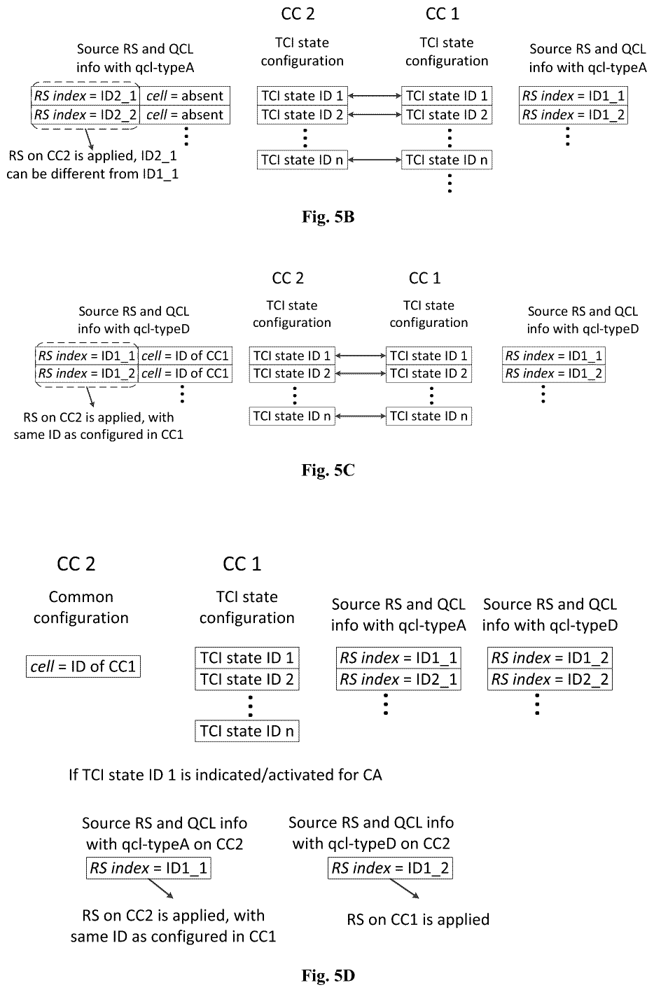

FIGS. 5A-5E illustrate examples in accordance with some embodiments of the present disclosure.

As shown in FIG. 5A, the terminal device 120 may be configured with that at least one TCI state on a second cell (e.g. CC2) refers to a first cell (e.g. CC1), a second TCI state configured on CC2 may correspond to or refer to a first TCI state configured with same value of ID with the second TCI state, and the first TCI state may be configured on CC1. For example, the second TCI state is configured with a value of ID to be “ID_1”, and the first TCI state is configured with same value of ID to be “ID_1”. As shown in FIG. 5A, the TCI state ID_1 on CC2 may correspond to or refer to the TCI state ID_1 on CC1, and the TCI state ID_2 on CC2 may correspond to or refer to the TCI state ID_1 on CC2, and so on.

As shown in FIG. 5B, the terminal device 120 may be configured with that at least one TCI state on a second cell (e.g. CC2) refers to a first cell (e.g. CC1). In some embodiments, for source RS and/or QCL info configured with qcl-Type to be qcl-TypeA, the RS configured on CC2 is applied for source RS. For example, the index of the RS associated with TCI state ID_1 on CC2 may be configured with ID2_1, and the index of the RS associated with TCI state ID_1 on CC1 may be configured with ID1_1. For example, the value of ID2_1 may be same with or different from the value of ID1_1.

In some embodiments, ID1_1 and ID2_1 may be non-negative integer. For example, 0<=ID1_1<=511. For example, 0<=ID2_1<=511.

As shown in FIG. 5C, the terminal device 120 may be configured with that at least one TCI state on a second cell (e.g. CC2) refers to a first cell (e.g. CC1). In some embodiments, for source RS and/or QCL info configured with qcl-Type to be qcl-TypeD, the RS configured on CC1 is applied for source RS for CC2. In some embodiments, the cell index in a TCI state configured on CC2 is configured as the index of the first cell (e.g. ID of CC1). For example, the index of the RS associated with TCI state ID_1 on CC1 may be configured with ID1_1, and the index of the RS associated with TCI state ID_1 on CC2 is expected to be configured with same value of ID1_1.

As shown in FIG. 5D, the terminal device 120 may be configured with a common configuration on the second cell (e.g. CC2). For example, the common configuration may include a configuration of CC. For example, the information of cell in the common configuration may be configured with index of the first cell (e.g. ID of CC1). In some embodiments, there may be a TCI state configured with TCI state ID_1 on the first cell. For example, there may be no TCI state (configured with TCI state ID_1) configuration on the second cell. In some embodiments, there may be a first RS configured in the TCI state ID_1 on the first cell, and the first RS may be associated or configured with qcl-TypeA, and the index of the RS may be configured with ID1_1. In some embodiments, there may be a second RS configured in the TCI state ID_1 on the first cell, and the second RS may be associated or configured with qcl-TypeD, and the index of the RS may be configured with ID1_2. In some embodiments, if the TCI state ID_1 is indicated/activated and applied for the first cell and/or the second cell, an RS with same value of ID1_1 which is configured on the second cell may be applied for source RS for qcl-TypeA for the second cell. In some embodiments, if the TCI state ID_1 is indicated/activated and applied for the first cell and/or the second cell, the second RS may be applied for source RS for qcl-TypeD for the second cell.

As shown in FIG. 5C, the terminal device 120 may be configured with a first list of TCI states (e.g. TCI state ID_1_1, . . . . TCI state ID_1_n) and a second list of TCI states (e.g. TCI state ID_2_1, . . . . TCI state ID_2_m) on the first cell. In some embodiments, if a TCI state in the first list is indicated/activated, the TCI state may be applied to the first cell and the second cell after the application timing. In some embodiments, if a TCI state in the second list is indicated/activated, the TCI state may be applied to the first cell (For example, the TCI state may be applied to non-UE dedicated and/or UE dedicated channel and/or RS on the first cell). For example, after the application timing. For example, the TCI state may not be applied to the second cell. In some embodiments, the previous or latest indicated/activated/applied TCI state which is included in the first list may be applied to the second cell.

In some embodiments, the terminal device 120 may receive at least one configuration for a first list of cells, wherein the first list of cells may comprise a first cell and a second list of cells, and at least a first spatial reception parameter or a source RS for qcl-TypeD of the second list of cells may refer to the first cell based on the at least one configuration. In some embodiments, the terminal device 120 may perform a first beam failure recovery procedure on the first list of cells. In some embodiments, the terminal device 120 may perform the first beam failure recovery procedure on the first cell, and perform a second beam failure recovery procedure on the second list of cells, wherein the second beam failure recovery procedure may be same with or related to the first beam failure recovery procedure.

In some embodiments, the first beam failure recovery procedure may be based on at least one of: a first set of parameters, wherein the first set of parameters comprises at least one of a first parameter for counter, a first parameter for timer and a first threshold; a first set of reference signals for beam failure detection; and a first set of reference signals for candidate beam identification.

In some embodiments, the second beam failure recovery procedure may be based on at least one of: a second set of parameters, wherein the second set of parameters comprises at least one of a second parameter for counter, a second parameter for timer and a second threshold; a second set of reference signals for beam failure detection; and a second set of reference signals for candidate beam identification.

In some embodiments, the terminal device 120 may receive an indication of a first transmission configuration indicator (TCI), and receive a first set of channels and/or reference signals based on the first spatial reception parameter on the first list of cells after or starting from the application timing, wherein the first spatial reception parameter may be based on the first TCI.

In some embodiments, the first set of parameters may be at least one of: configured on the first cell; configured and shared for the first list of cells and determined based on a set of parameters with a maximum or minimum value among the first list of cells.

In some embodiments, the first set of reference signals for beam failure detection may be at least one of: configured on the first cell; configured and shared for the first list of cells; determined based on TCI states for a set of control resource sets (CORESETs) on the first cell and determined based on the first TCI;

In some embodiments, the first set of reference signals for candidate beam identification may be at least one of: configured on the first cell and configured and shared for the first list of cells.

In some embodiments, the second set of parameters may be at least one of: same with the first set of parameters;
the second set of reference signals for beam failure detection is same with or a subset of the first set of reference signals for beam failure detection; configured on the first cell; configured and shared for the first list of cells; configured and shared for the second list of cells; determined based on a set of parameters with a maximum or minimum value among the first list of cells; and determined based on a set of parameters with a maximum or minimum value among the second list of cells;

In some embodiments, the second set of reference signals for candidate beam identification may be at least one of: same with or a subset of the first set of reference signals for beam failure detection; configured on the first cell; configured and shared for the first list of cells; configured and shared for the second list of cells; determined based on TCI states for a set of control resource sets (CORESETs) on the first cell; determined based on TCI states for a set of control resource sets (CORESETs) on the second list of cells and determined based on the first TCI.

In some embodiments, the second set of reference signals for candidate beam identification may be at least one of: configured on the first cell; configured and shared for the first list of cells and configured and shared for the second list of cells.

In some embodiments, the first beam failure recovery procedure and/or the second beam failure recovery procedure may be stopped or suspended or reset, if a number of ports for a source reference signal configured with quasi co-location (QCL) typeD in the first TCI is equal to and/or larger than 2.

In some embodiments, the terminal device 120 may transmit at least one information to the network device, wherein the at least one information may be at least one of: a single indication to indicate beam failure detection for the first list of cells or the second list of cells; a single indication to indicate presence of a new reference signal for the first list of cells or the second list of cells; a single indication to indicate an index of the new reference signal for the first list of cells or the second list of cells; a list of indications to indicate beam failure detection for the first list of cells or the second list of cells, wherein each indication in the list indicates beam failure detection for one cell in the first list of cells or in the second list of cells, and the values of the indications in the list may be same; a list of indications to indicate presence of new reference signal(s) for the first list of cells or the second list of cells, wherein each indication in the list indicates presence of a new reference signal for one cell in the first list of cells or the second list of cells, and the values of the indications in the list may be same; and a list of indications to indicate index(es) of new reference signal(s) for the first list of cells or the second list of cells, wherein each indication in the list indicates an index of the new reference signal for one cell in the first list of cells or the second list of cells, and the values of the indications in the list may be same.

In some embodiments, the new reference signal may be comprised in the first set of reference signals for candidate beam identification or the second set of reference signals for candidate beam identification.

In some embodiments, the terminal device 120 may monitor or receive at least one physical downlink control channel (PDCCH) in corresponding CORESETs on at least one cell in the first list of cells or the second list of cells using same antenna port QCL parameters as the ones associated with the new reference signal after or starting from a first timing. In some embodiments, the terminal device 120 may receive at least one physical downlink shared channel (PDSCH) on at least one cell in the first list of cells or the second list of cells using same antenna port QCL parameters as the ones associated with the new reference signal after or starting from the first timing, wherein the at least one PDSCH is scheduled by the at least one PDCCH. In some embodiments, the terminal device 120 may transmit a physical uplink control channel (PUCCH) on the first cell using a same spatial domain filter as the one corresponding to the new reference signal after or starting from the first timing. In some embodiments, the terminal device 120 may transmit at least one physical uplink shared channel (PUSCH) on at least one cell in the first list of cells or the second list of cells using a same spatial domain filter as the one corresponding to the new reference signal after or starting from the first timing.

In some embodiments, the TCI field in a DCI in the PDCCH may be 0 bit or omitted. In some embodiments, the terminal device 120 may assume or expect to receive the index of codepoint in the TCI field in the DCI in the PDCCH to be same with the index of codepoint with the first TCI.

In some embodiments, the terminal device 120 may perform a beam failure recovery procedure on each cell in the first list of cells respectively, if an index of cell index information for spatial reception parameter on the cell is absent based on the at least one configuration.

In some embodiments, in response to a first beam failure detection is detected in the first beam failure recovery procedure, the terminal device 120 may transmit to the network device, at least one of the following: an indication to indicate beam failure detection for the first cell; an indication to indicate presence of a new reference signal for the first cell; and an indication to indicate an index of the new reference signal for the first cell, wherein the new reference signal is comprised in the first set of reference signals for candidate beam identification.

In some embodiments, in response to a first beam failure detection is detected in the first beam failure recovery procedure, the terminal device 120 may monitor a PDCCH in a search space set provided by recoverySearchSpaceld after or starting from the first timing.

In some embodiments, in response to a first beam failure detection is detected in the first beam failure recovery procedure, the terminal device 120 may receive at least one PDSCH on the first cell using same antenna port QCL parameters as the ones associated with the new reference signal after or starting from the first timing. For example, the at least one PDSCH may be scheduled by the PDCCH in the search space set.

In some embodiments, in response to a first beam failure detection is detected in the first beam failure recovery procedure, the terminal device 120 may transmit a PUCCH on the first cell using a same spatial domain filter as the one corresponding to the new reference signal after or starting from the first timing, to the network device.

In some embodiments, in response to a first beam failure detection is detected in the first beam failure recovery procedure, the terminal device 120 may transmit at least one PUSCH on the first cell using a same spatial domain filter as the one corresponding to the new reference signal after or starting from the first timing.

In some embodiments, in response to a first beam failure detection is detected in the first beam failure recovery procedure, the terminal device 120 may monitor at least one PDCCH in corresponding CORESETs on at least one cell in the first list of cells or the second list of cells based on a second TCI indicated in a PDCCH on the first cell after or starting from a second timing. For example, the PDCCH on the first cell may be received after the first timing.

In some embodiments, in response to a first beam failure detection is detected in the first beam failure recovery procedure, the terminal device 120 may monitor at least one PDCCH in corresponding CORESETs on at least one cell in the first list of cells or the second list of cells using same antenna port QCL parameters as the ones associated with the new reference signal after or starting from the second timing.

In some embodiments, in response to a first beam failure detection is detected in the first beam failure recovery procedure, the terminal device 120 may receive at least one PDSCH on at least one cell in the first list of cells or the second list of cells using same antenna port QCL parameters as the ones associated with the new reference signal or based on the second TCI after or starting from the second timing. For example, the at least one PDSCH may be scheduled by the at least one PDCCH; and

In some embodiments, in response to a first beam failure detection is detected in the first beam failure recovery procedure, the terminal device 120 may transmit at least one PUSCH on at least one cell in the first list of cells or the second list of cells using a same spatial domain filter as the one corresponding to the new reference signal or based on the second TCI after or starting from the second timing.

In some embodiments, in response to a second beam failure detection is detected in the second beam failure recovery procedure, the terminal device 120 may transmit the at least one information in a first PUSCH to the network device.

In some embodiments, in response to a second beam failure detection is detected in the second beam failure recovery procedure, the terminal device 120 may monitor at least one PDCCH in corresponding CORESETs on at least one cell in the first list of cells or the second list of cells using same antenna port QCL parameters as the ones associated with the new reference signal after or starting from the first timing.

In some embodiments, in response to a second beam failure detection is detected in the second beam failure recovery procedure, the terminal device 120 may receive at least one PDSCH on at least one cell in the first list of cells or the second list of cells using same antenna port QCL parameters as the ones associated with the new reference signal after or starting from the first timing. For example, the at least one PDSCH may be scheduled by the at least one PDCCH.

In some embodiments, in response to a second beam failure detection is detected in the second beam failure recovery procedure, the terminal device 120 may transmit a PUCCH on the first cell using a same spatial domain filter as the one corresponding to the new reference signal after or starting from the first timing.

In some embodiments, in response to a second beam failure detection is detected in the second beam failure recovery procedure, the terminal device 120 may transmit at least one PUSCH on at least one cell in the first list of cells or the second list of cells using a same spatial domain filter as the one corresponding to the new reference signal after or starting from the first timing.

In some embodiments, the second beam failure detection may be detected in the second beam failure recovery procedure, and the first beam failure detection may not detected in the first beam failure recovery procedure.

In some embodiments, the PDCCH on the first cell may comprise at least use equipment (UE) dedicated PDCCH. In some embodiments, the PDCCH on the first cell may be in a UE specific search space (USS). In some embodiments, the PDCCH on the first cell may be in a common search space (CSS), wherein a demodulation reference signal for the PDCCH may be configured to share a same indicated TCI for a UE dedicated channel.

In some embodiments, the first timing may be at least one of: slot n+4, wherein slot n is a slot for physical random access channel (PRACH) transmission for the first beam failure recovery procedure on the first cell; 28 symbols from a last symbol of a last symbol of a first PDCCH reception in the search space set provided by recoverySearchSpaceId on the first cell; 28 symbols from a last symbol of a PDCCH reception with a downlink control information (DCI) scheduling a PUSCH transmission with a same hybrid automatic repeat request (HARQ) process number as for the transmission of the first PUSCH and having a toggled new data indicator (NDI) field value, wherein subcarrier spacing (SCS) configuration for the 28 symbols is the smallest of SCS configurations for the first list of cells or the second list of cells; and a first slot after 28 symbols from a last symbol of a PDCCH reception with a DCI scheduling a PUSCH transmission with a same HARQ process number as for the transmission of the first PUSCH and having a toggled NDI field value, wherein subcarrier spacing (SCS) configuration for the 28 symbols may be the smallest of SCS configurations for the first list of cells or the second list of cells.

In some embodiments, the second timing may be at least one of: a first slot after a number of symbols from a last symbol of the first PDCCH reception in the search space set provided by recoverySearchSpaceld on the first cell; a first slot after or starting from the first beam failure recovery procedure is completed; and a first slot after the number of symbols from a last symbol of an acknowledgement corresponding to the first PDCCH reception or a PDSCH scheduled by the first PDCCH.

In some embodiments, the terminal device 120 may receive from the network device, at least one configuration for a set of transmission configuration indicator (TCI) states, and the set of TCI states may be at least one of: a first subset of TCI states, wherein at least one reference signal (RS) in a TCI state of the first subset may be associated with a first physical cell identity (ID); and a second subset of TCI states, wherein at least one RS in a TCI state of the second subset may be associated with a second physical cell ID.

In some embodiments, the terminal device 120 may perform a beam failure recovery procedure based on at least one of a first set of RS for beam failure detection and a first set of RS for candidate beam identification, in case of a first TCI state of the first subset is indicated. In some embodiments, the terminal device 120 may perform a beam failure recovery procedure based on at least one of a second set of RS for beam failure detection and a second set of RS for candidate beam identification, in case of a second TCI state of the second subset is indicated.

In some embodiments, the at least one configuration for the set of TCI states may be configured for a first cell, wherein the first cell may be associated with the first physical cell ID.

In some embodiments, the first set of RS for beam failure detection may be associated with the first physical cell ID. In some embodiments, the first set of RS for candidate beam identification may be associated with the first physical cell ID. In some embodiments, the second set of RS for beam failure detection may be associated with the second physical cell ID. In some embodiments, the second set of RS for candidate beam identification may be associated with the first physical cell ID and/or the second physical cell ID.

In some embodiments, the first set of RS for beam failure detection may be at least one of: configured on the first cell; determined based on at least one TCI state for a first set of control resource sets (CORESETs) on the first cell, wherein the at least one TCI state may be associated with the first physical cell ID and/or the second physical cell ID; determined based on the first TCI state.

In some embodiments, the first set of RS for candidate beam identification is configured on the first cell.

In some embodiments, the second set of RS for beam failure detection may be at least one of: configured on the first cell; determined based on at least one TCI state for a second set of control resource sets (CORESETs) on the first cell, wherein the at least one TCI state may be associated with the first physical cell ID and/or the second physical cell ID; and determined based on the second TCI state.

In some embodiments, the second set of RS for candidate beam identification may be configured on the first cell.

In some embodiments, the terminal device 120 may receive at least one configuration for a first list of cells, wherein the first list of cells may comprise the first cell and a second list of cells, and at least a first spatial reception parameter of the second list of cells may refer to the first cell based on the at least one configuration for the first list of cells.

In some embodiments, in response to the first TCI state is indicated, the terminal device 120 may monitor or receive at least one physical downlink control channel (PDCCH) in corresponding CORESETs on at least one cell in the first list of cells based on the first TCI state after or starting from an application timing.

In some embodiments, in response to the first TCI state is indicated, the terminal device 120 may receive at least one physical downlink shared channel (PDSCH) on at least one cell in the first list of cells based on the first TCI state after or starting from the application timing, wherein the at least one PDSCH is scheduled by the at least one PDCCH.

In some embodiments, in response to the first TCI state is indicated, the terminal device 120 may transmit a physical uplink control channel (PUCCH) on the first cell based on the first TCI state after or starting from the application timing.

In some embodiments, in response to the first TCI state is indicated, the terminal device 120 may transmit at least one physical uplink shared channel (PUSCH) on at least one cell in the first list of cells based on the first TCI state after or starting from the application timing.

In some embodiments, in response to the second TCI state is indicated, the terminal device 120 may monitor or receive at least one PDCCH in corresponding CORESETs on the first cell based on the second TCI state after or starting from the application timing.

In some embodiments, in response to the second TCI state is indicated, the terminal device 120 may receive at least one PDSCH on the first cell based on the second TCI state after or starting from the application timing. For example, the at least one PDSCH may be scheduled by the at least one PDCCH;

In some embodiments, in response to the second TCI state is indicated, the terminal device 120 may transmit a PUCCH on the first cell based on the second TCI state after or starting from the application timing.

In some embodiments, in response to the second TCI state is indicated, the terminal device 120 may transmit at least one PUSCH on the first cell based on the second TCI state after or starting from the application timing.

In some embodiments, in response to the second TCI state is indicated, the terminal device 120 may perform no monitoring or receiving or transmitting on the second list of cells after or starting from the application timing.

In some embodiments, in response to the second TCI state is indicated, the terminal device 120 may monitor or receive at least one PDCCH in corresponding CORESETs on at least one cell in the second list of cells based on a latest or previous TCI state.

In some embodiments, in response to the second TCI state is indicated, the terminal device 120 may receive at least one PDSCH on at least one cell in the second list of cells based on the latest or previous TCI state.

In some embodiments, in response to the second TCI state is indicated, the terminal device 120 may transmit at least one PUSCH on at least one cell in the second list of cells based on the latest or previous TCI state, wherein the latest or previous TCI state may be associated with the first physical cell ID.

In some embodiments, the application timing may be a first slot which is a number of symbols after a last symbol of an acknowledgement corresponding to a PDCCH or a PDSCH scheduled by the PDCCH, wherein the first TCI state or the second TCI state may be indicated in the PDCCH.

In some embodiments, the first physical cell ID may be the cell ID of the serving cell. In some embodiments, the second physical cell ID may be different from the first physical cell ID. In some embodiments, the second physical cell ID may be an ID different from the serving cell. For example, the second physical cell ID may be an ID of a neighbor cell.

In some embodiments, if a first TCI state is indicated/activated. For example, the first TCI state may be in the first list of TCI states. For example, the first TCI state may be applied to the first cell and the second cell or the first list of cells after the application timing. In some embodiments, the terminal device 120 may perform a first beam failure recovery procedure for the second cell based on configurations/parameters on the first cell. In some embodiments, the terminal device 120 may perform a common/unified/first beam failure recovery procedure on the first cell and the second cell.

In some embodiments, the parameters for the first beam failure recovery procedure may be based on at least one configuration on the first cell or based on the maximum/minimum value between configuration on the first cell and configuration the second cell or among the configurations on the first list of cells or among the configurations on the second list of cells. In some embodiments, the parameters may include at least one of: beamFailureInstanceMaxCount; beamFailureDetection Timer and rsrp-Threshold, candidateBeamRSList.

In some embodiments, beam failure detection (BFD) RS set for the first beam failure recovery procedure may be determined based on the RS configured with qcl-typeD in the first TCI state on the first cell or the BFD RS set may be determined based on RS in TCI states for respective CORESETs on the first cell. For example, the terminal device 120 may not expect the source RS (e.g. CSI-RS for channel state information (CSI) as source RS) for qcl-typeD in the first TCI state is not 1 and/or 2 ports. For example, if source RS for qcl-typeD in the first TCI state is not 1 and/or 2 ports, the first beam failure recovery (BFR) may be suspended or stopped. For example, if source RS for qcl-typeD in the first TCI state is not 1 and/or 2 ports, the terminal device 120 may determine a CSI-RS with 1 and/or 2 ports to be BFD RS. And the CSI-RS may be a source RS for qcl-typeD for the source RS in the first TCI state is applied for BFD RS. In some embodiments, the beam failure detection RS is based on BFD RS set configured in the first cell.

In some embodiments, if beam failure is declared, values of beam failure indication field in MAC CE may be same for the first cell and the second cell.

In some embodiments, a new beam or RS may be identified from a candidate beam RS list. For example, the new beam or RS may be for both the first cell and the second cell or for the first list of cells or for the second list of cells. In some embodiments, the candidate beam RS list may be configured in first cell or may be a common candidate beam RS list configured for the first cell and the second cell or for the first list of cells or for the second list of cells. In some embodiments, in the MAC CE, presence of new beam or RS and index(es) of the new beam or RS may be same for the first cell and the second cell or for the first list of cells or for the second list of cells.

In some embodiments, the new beam or RS may be represented as qnew in this disclosure.

In some embodiments, a first qnew and a second qnew are identified from the candidate beam RS list configured in the first cell and the second cell respectively. For example, after the first beam failure recovery is successful, the beam may not be unified for the first cell and the second cell, until a new TCI state is activated/indicated and applied to the first cell and second cell.

In some embodiments, the terminal device 120 may monitor PDCCH on the first cell and the second cell after the first timing, and the PDCCH may be based on the QCL parameters associated with qnew.

In some embodiments, qnew may replace the source RS configured in the first TCI state or qnew may replace the first TCI state in the corresponding TCI codepoint or qnew may replace the source RS for qcl-TypeD configured in the first TCI state after the first beam failure recovery procedure is successful. For example, until a new TCI state is indicated/activated for the first cell and second cell. For example, the qnew may be a periodic CSI-RS. For example, the number of ports for qnew may be 1 or 2 ports. In some embodiments, if qnew is a synchronization signal (SS)/physical broadcast channel (PBCH), qnew may not replace the source RS configured in the first TCI state. In some embodiments, the source RS for qcl-TypeA configured in the first TCI state may be still applied.

In some embodiments, the terminal device 120 may receive an indication/activation of a second TCI state, and the field of cell information in source RS and QCL info in the second TCI state on the second cell may be absent. The terminal device 120 may perform a second beam failure recovery procedure on the second cell. For example, the second beam failure recovery procedure may be separate from the first beam failure recovery procedure. In some embodiments, the beam failure detection RS may be configured on the second cell or determined based on the RS on the second cell. For example, the RS may be configured in the second TCI state and for source RS and QCL info configured with qcl-TypeD. In some embodiments, the parameters for the second beam failure recovery procedure may be configured on the second cell. In some embodiments, the RS set for candidate beam identification for the second beam failure recovery procedure may be configured on the second cell or configured on the first cell or configured for the first/second list of cells. In some embodiments, there may be a plurality of TCI states configured on the second cell, and at least the source RS for qcl-TypeD or spatial reception parameter for different TCI states may refer to different cells, the RS set for candidate beam identification for the second beam failure recovery procedure may be the RS set configured on the cell with lowest ID among the different cells.

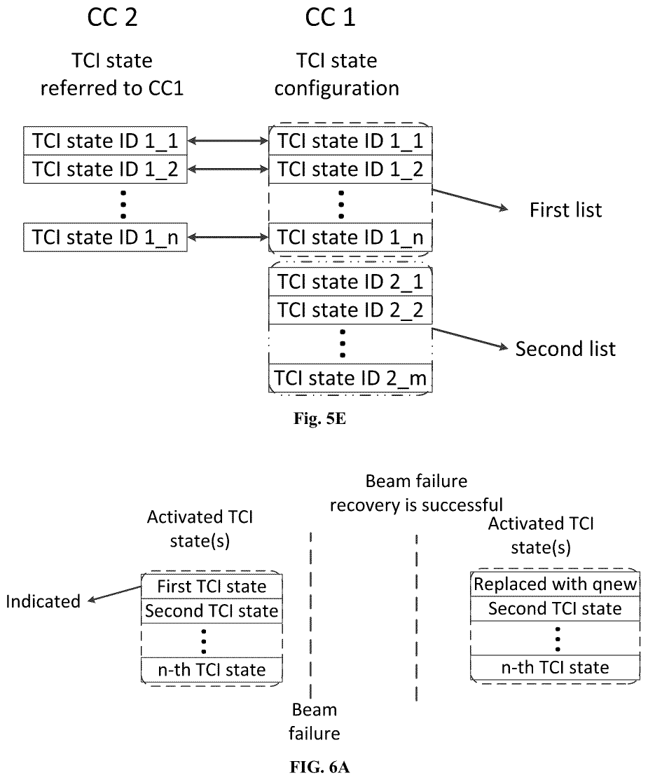

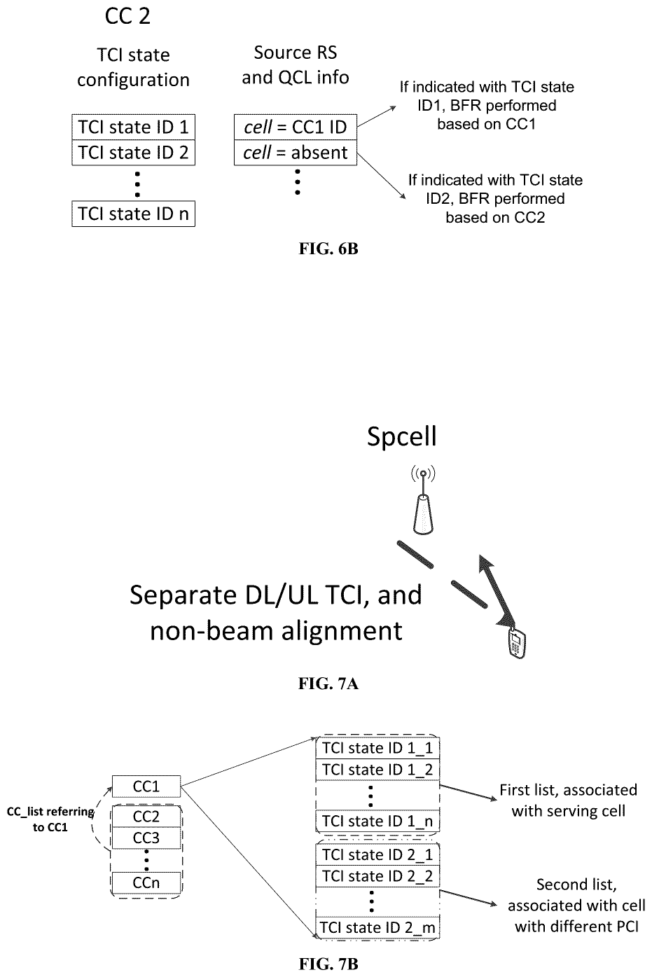

FIGS. 6A-6B illustrate examples in accordance with some embodiments of the present disclosure.

As shown in FIG. 6A, the terminal device 120 may be activated with a list of TCI states. For example, via MAC CE. In some embodiments, the terminal device 120 may be indicated with a first TCI state. For example, the first TCI state may be applied for the first cell and second cell after the application timing. In some embodiments, if beam failure is detected on the first cell and/or second cell. After beam failure recovery is successful, the first TCI state or the TCI codepoint corresponding to the first TCI state or the source RS for qcl-TypeA and/or source RS for qcl-TypeD in the first TCI state may be replaced with qnew. For example, qnew may be identified from the RS set for candidate beam identification for the first cell and/or the second cell.

As shown in FIG. 6B, the terminal device 120 may be configured with at least one TCI state on the second cell (e.g. CC2). In some embodiments, for a first TCI state (e.g. TCI state ID_1), cell information for source RS and/or QCL info configured with qcl-Type to be qcl-TypeA may be configured as the cell index of the first cell (e.g. CC1 ID). In some embodiments, for a second TCI state (e.g. TCI state ID_2), cell information for source RS and/or QCL info configured with qcl-Type to be qcl-TypeA may be configured as absent. In some embodiments, if the terminal device 120 is indicated with the first TCI state ID_1, the beam failure recovery for the second cell may be performed based on the first cell. In some embodiments, if the terminal device 120 is indicated with the second TCI state ID2, the beam failure recovery for the second cell may be performed based on the second cell.

In some embodiments, the first cell may be a primary cell. For example, the first cell is a Pcell or an Spcell or a Pscell. For example, the first beam failure recovery procedure may be based on random access channel (RACH).

In some embodiments, the terminal device 120 may monitor PDCCH in a search space set provided by recoverySearchSpaceld after or starting from the first timing on the first cell. For example, in case of beam failure is detected/declared on the first cell and/or the second cell. For another example, after beam failure recovery request is transmitted to the network device. In some embodiments, the terminal device 120 may monitor PDCCH in corresponding CORESETs after or starting from the second timing. In some embodiments, the terminal device 120 may not monitor PDCCH on the second cell. For example, until a new TCI state is indicated/activated for the first cell and/or the second cell. For example, after the application timing.

In some embodiments, if a first TCI state is indicated/activated. For example, the first TCI state may be in the first list of TCI states. For example, the first TCI state may be applied to the first cell and the second cell or the first list of cells after the application timing. In some embodiments, the first cell may be at least one of: a Pcell, a primary cell, a Pscell, an Spcell. In some embodiments, the terminal device 120 may perform a first beam failure recovery procedure (for example, RACH based) for the first cell.

In some embodiments, the parameters for the first beam failure recovery procedure may be based on at least one configuration on the first cell or based on the maximum/minimum value between configuration on the first cell and configuration the second cell or among the configurations on the first list of cells or among the configurations on the second list of cells. In some embodiments, the parameters may include at least one of: beamFailureInstanceMaxCount; beamFailureDetection Timer and rsrp-Threshold, candidateBeamRSList.

In some embodiments, beam failure detection (BFD) RS set for the first beam failure recovery procedure may be determined based on the RS configured with qcl-typeD in the first TCI state on the first cell or the BFD RS set may be determined based on RS in TCI states for respective CORESETs on the first cell. For example, the terminal device 120 may not expect the source RS (e.g. CSI-RS for channel state information (CSI) as source RS) for qcl-typeD in the first TCI state is not 1 and/or 2 ports. For example, if source RS for qcl-typeD in the first TCI state is not 1 and/or 2 ports, the first beam failure recovery (BFR) may be suspended or stopped. For example, if source RS for qcl-typeD in the first TCI state is not 1 and/or 2 ports, the terminal device 120 may determine a CSI-RS with 1 and/or 2 ports to be BFD RS. And the CSI-RS may be a source RS for qcl-typeD for the source RS in the first TCI state is applied for BFD RS. In some embodiments, the beam failure detection RS is based on BFD RS set configured in the first cell.

In some embodiments, if beam failure is declared, values of beam failure indication field in MAC CE may be same for the first cell and the second cell.

In some embodiments, a new beam or RS may be identified from a candidate beam RS list. For example, the new beam or RS may be for both the first cell and the second cell or for the first list of cells or for the second list of cells. In some embodiments, the candidate beam RS list may be configured in first cell or may be a common candidate beam RS list configured for the first cell and the second cell or for the first list of cells or for the second list of cells. In some embodiments, in the MAC CE, presence of new beam or RS and index(es) of the new beam or RS may be same for the first cell and the second cell or for the first list of cells or for the second list of cells.

In some embodiments, the new beam or RS may be represented as qnew in this disclosure.

In some embodiments, a first qnew and a second qnew are identified from the candidate beam RS list configured in the first cell and the second cell respectively. For example, after the first beam failure recovery is successful, the beam may not be unified for the first cell and the second cell, until a new TCI state is activated/indicated and applied to the first cell and second cell.

In some embodiments, the terminal device 120 may monitor PDCCH on the first cell and the second cell after the first timing, and the PDCCH may be based on the QCL parameters associated with qnew.

In some embodiments, qnew may replace the source RS configured in the first TCI state or qnew may replace the first TCI state in the corresponding TCI codepoint after the first beam failure recovery procedure is successful. For example, until a new TCI state is indicated/activated for the first cell and second cell. For example, the qnew may be a periodic CSI-RS. For example, the number of ports for qnew may be 1 or 2 ports. In some embodiments, if qnew is a synchronization signal (SS)/physical broadcast channel (PBCH), qnew may not replace the source RS configured in the first TCI state.

In some embodiments, the terminal device 120 may receive an indication/activation of a second TCI state, and the field of cell information in source RS and QCL info in the second TCI state on the second cell may be absent. The terminal device 120 may perform a second beam failure recovery procedure on the second cell. For example, the second beam failure recovery procedure may be separate from the first beam failure recovery procedure. In some embodiments, the beam failure detection RS may be configured on the second cell or determined based on the RS on the second cell. For example, the RS may be configured in the second TCI state and for source RS and QCL info configured with qcl-TypeD. In some embodiments, the parameters for the second beam failure recovery procedure may be configured on the second cell. In some embodiments, the RS set for candidate beam identification for the second beam failure recovery procedure may be configured on the second cell or configured on the first cell or configured for the first/second list of cells. In some embodiments, there may be a plurality of TCI states configured on the second cell, and at least the source RS for qcl-TypeD or spatial reception parameter for different TCI states may refer to different cells, the RS set for candidate beam identification for the second beam failure recovery procedure may be the RS set configured on the cell with lowest ID among the different cells.

In some embodiments, the terminal device 120 may perform a second beam failure recovery procedure (for example, PUCCH based. For another example, Scell BFR.) for the second cell or the second list of cells.

In some embodiments, the parameters for the second beam failure recovery procedure may be based on at least one configuration on the first cell or based on the maximum/minimum value between configuration on the first cell and configuration the second cell or among the configurations on the first list of cells or among the configurations on the second list of cells. In some embodiments, the parameters may include at least one of: beamFailureInstanceMaxCount; beam FailureDetection Timer and rsrp-Threshold, candidateBeamRSList.

In some embodiments, beam failure detection (BFD) RS set for the second beam failure recovery procedure may be different from the BFD RS set for the first beam failure recovery procedure. In some embodiments, beam failure detection (BFD) RS set for the second beam failure recovery procedure may be determined based on the RS configured with qcl-typeD in the first TCI state on the first cell or the BFD RS set may be determined based on RS in TCI states for respective CORESETs on the second cell or the second list of cells. For example, the terminal device 120 may not expect the source RS (e.g. CSI-RS for channel state information (CSI) as source RS) for qcl-typeD in the first TCI state is not 1 and/or 2 ports. For example, if source RS for qcl-typeD in the first TCI state is not 1 and/or 2 ports, the first beam failure recovery (BFR) may be suspended or stopped. For example, if source RS for qcl-typeD in the first TCI state is not 1 and/or 2 ports, the terminal device 120 may determine a CSI-RS with 1 and/or 2 ports to be BFD RS. And the CSI-RS may be a source RS for qcl-typeD for the source RS in the first TCI state is applied for BFD RS. In some embodiments, the beam failure detection RS is based on BFD RS set configured in the first cell.

In some embodiments, a new beam or RS may be identified from a candidate beam RS list. For example, the new beam or RS may be for both the first cell and the second cell or for the first list of cells or for the second list of cells. In some embodiments, the candidate beam RS list may be configured in first cell or may be a common candidate beam RS list configured for the first cell and the second cell or for the first list of cells or for the second list of cells. In some embodiments, in the MAC CE, presence of new beam or RS and index(es) of the new beam or RS may be same for the first cell and the second cell or for the first list of cells or for the second list of cells.

In some embodiments, a first qnew and a second qnew are identified from the candidate beam RS list configured in the first cell and the second cell respectively. For example, after the first beam failure recovery is successful, the beam may not be unified for the first cell and the second cell, until a new TCI state is activated/indicated and applied to the first cell and second cell.

In some embodiments, if beam failure is detected/declared in the second beam failure recovery procedure, and/or if beam failure is not detected/declared in the first beam failure recovery procedure, the terminal device 120 may monitor at least UE dedicated PDCCH on the first cell based on the QCL parameters associated with qnew. For example, after the first or second timing. And the terminal device 120 may monitor PDCCH in corresponding CORESETs on the second cell or the second list of cells based on the QCL parameters associated with qnew. For example, after the first or second timing.

In some embodiments, if beam failure is detected/declared in the first beam failure recovery procedure, (for example, no matter whether beam failure is detected/declared or not in the second beam failure recovery procedure), the terminal device 120 may monitor PDCCH in a search space set provided by recoverySearchSpaceld after or starting from the first timing on the first cell. For example, in case of beam failure is detected/declared on the first cell and/or the second cell. For another example, after beam failure recovery request is transmitted to the network device. In some embodiments, the terminal device 120 may monitor PDCCH in corresponding CORESETs on the second cell or the second list of cells after or starting from the second timing. In some embodiments, the terminal device 120 may not monitor PDCCH on the second cell. For example, until a new TCI state is indicated/activated for the first cell and/or the second cell. For example, after the application timing.

In some embodiments, the first cell may be an Scell, and there may be a Pcell or Pscell or primary cell or Spcell (e.g. represented as Spcell) in the second list of cells. In some embodiments, if a first TCI state is indicated/activated. For example, the first TCI state may be in the first list of TCI states. For example, the first TCI state may be applied to the first cell and the second cell or the first list of cells after the application timing. In some embodiments, the terminal device 120 may perform a first beam failure recovery procedure (for example, RACH based) for the Spcell.

In some embodiments, the parameters for the first beam failure recovery procedure may be based on at least one configuration on the first cell or on the Spcell or based on the maximum/minimum value between configuration on the first cell and configuration the second cell or among the configurations on the first list of cells or among the configurations on the second list of cells. In some embodiments, the parameters may include at least one of: beamFailureInstanceMaxCount; beamFailureDetection Timer and rsrp-Threshold, candidateBeamRSList.

In some embodiments, beam failure detection (BFD) RS set for the first beam failure recovery procedure may be determined based on the RS configured with qcl-typeD in the first TCI state on the first cell or on the Spcell or the BFD RS set may be determined based on RS in TCI states for respective CORESETs on the Spcell. For example, the terminal device 120 may not expect the source RS (e.g. CSI-RS for channel state information (CSI) as source RS) for qcl-typeD in the first TCI state is not 1 and/or 2 ports. For example, if source RS for qcl-typeD in the first TCI state is not 1 and/or 2 ports, the first beam failure recovery (BFR) may be suspended or stopped. For example, if source RS for qcl-typeD in the first TCI state is not 1 and/or 2 ports, the terminal device 120 may determine a CSI-RS with 1 and/or 2 ports to be BFD RS. And the CSI-RS may be a source RS for qcl-typeD for the source RS in the first TCI state is applied for BFD RS. In some embodiments, the beam failure detection RS is based on BFD RS set configured in the first cell or in the Spcell cell.

In some embodiments, a new beam or RS may be identified from a candidate beam RS list. For example, the new beam or RS may be for both the first cell and the second cell or for the first list of cells or for the second list of cells. In some embodiments, the candidate beam RS list may be configured in first cell or in the Spcell or may be a common candidate beam RS list configured for the first cell and the second cell or for the first list of cells or for the second list of cells. In some embodiments, in the MAC CE, presence of new beam or RS and index(es) of the new beam or RS may be same for the first cell and the second cell or for the first list of cells or for the second list of cells.

In some embodiments, a first qnew and a second qnew are identified from the candidate beam RS list configured in the first cell and the second cell respectively. For example, after the first beam failure recovery is successful, the beam may not be unified for the first cell and the second cell, until a new TCI state is activated/indicated and applied to the first cell and second cell.

In some embodiments, the terminal device 120 may perform a second beam failure recovery procedure (for example, PUCCH based. For another example, Scell BFR.) for the first cell and/or the second list of cells excluding the Spcell or the first list of cells excluding the Spcell.

In some embodiments, the parameters for the second beam failure recovery procedure may be based on at least one configuration on the first cell or based on the maximum/minimum value or among the configurations on the first list of cells excluding the Spcell or among the configurations on the second list of cells excluding the Spcell. In some embodiments, the parameters may include at least one of: beamFailure InstanceMaxCount; beamFailureDetection Timer and rsrp-Threshold, candidateBeamRSList.

In some embodiments, beam failure detection (BFD) RS set for the second beam failure recovery procedure may be different from the BFD RS set for the first beam failure recovery procedure. In some embodiments, beam failure detection (BFD) RS set for the second beam failure recovery procedure may be determined based on the RS configured with qcl-typeD in the first TCI state on the first cell or the BFD RS set may be determined based on RS in TCI states for respective CORESETs on the first/second list of cells excluding the Spcell. For example, the terminal device 120 may not expect the source RS (e.g. CSI-RS for channel state information (CSI) as source RS) for qcl-typeD in the first TCI state is not 1 and/or 2 ports. For example, if source RS for qcl-typeD in the first TCI state is not 1 and/or 2 ports, the first beam failure recovery (BFR) may be suspended or stopped. For example, if source RS for qcl-typeD in the first TCI state is not 1 and/or 2 ports, the terminal device 120 may determine a CSI-RS with 1 and/or 2 ports to be BFD RS. And the CSI-RS may be a source RS for qcl-typeD for the source RS in the first TCI state is applied for BFD RS. In some embodiments, the beam failure detection RS is based on BFD RS set configured in the first cell.

In some embodiments, a new beam or RS may be identified from a candidate beam RS list. For example, the new beam or RS may be for both the first cell and the second cell or for the first list of cells excluding the Spcell or for the second list of cells excluding the Spcell. In some embodiments, the candidate beam RS list may be configured in first cell or may be a common candidate beam RS list configured for the first cell and the second cell or for the first list of cells or for the second list of cells. In some embodiments, in the MAC CE, presence of new beam or RS and index(es) of the new beam or RS may be same for the first cell and the second cell or for the first list of cells or for the second list of cells.

In some embodiments, if beam failure is detected/declared in the second beam failure recovery procedure, and/or if beam failure is not detected/declared in the first beam failure recovery procedure, the terminal device 120 may monitor at least UE dedicated PDCCH on the Spcell cell based on the QCL parameters associated with qnew. For example, after the first or second timing. And the terminal device 120 may monitor PDCCH in corresponding CORESETs on the first cell and/or the second list of cells excluding the Spcell based on the QCL parameters associated with qnew. For example, after the first or second timing.

In some embodiments, if beam failure is detected/declared in the first beam failure recovery procedure, (for example, no matter whether beam failure is detected/declared or not in the second beam failure recovery procedure), the terminal device 120 may monitor PDCCH in a search space set provided by recoverySearchSpaceld after or starting from the first timing on the Spcell cell. For example, in case of beam failure is detected/declared on the Spcell. For another example, after beam failure recovery request is transmitted to the network device. In some embodiments, the terminal device 120 may monitor PDCCH in corresponding CORESETs on the first list of cells excluding the Spcell after or starting from the second timing. In some embodiments, the terminal device 120 may not monitor PDCCH on the first list of cells excluding the Spcell. For example, until a new TCI state is indicated/activated for the first cell and/or the second cell or for the first list of cells. For example, after the application timing.

In some embodiments, if an Spcell is included in the first list of cells, the Spcell may be assumed or expected to be configured as a reference cell for the first list of cells.

In some embodiments, the terminal device 120 may be configured with a mode of joint TCI or a mode of separate downlink (DL)/uplink (UL) TCI on an Spcell. In some embodiments, if the terminal device 120 is configured with a mode of separate DL/UL TCI on the Spcell, and if the indicated/activated/applied DL TCI and the indicated/activated/applied UL TCI is not a case of beam alignment, the terminal device 120 may perform a PUCCH based BFR in case of beam failure is detected/declared on the Spcell. For example, otherwise, the terminal device 120 may perform RACH based BFR in case of beam failure is detected/declared on the Spcell. In some embodiments, if the terminal device 120 is configured with a mode of joint TCI on the Spcell, or if the terminal device 120 is configured separate DL/UL TCI on the Spcell, and if the indicated/activated/applied DL TCI and the indicated/activated/applied UL TCI is a case of beam alignment, the terminal device 120 may perform a PUCCH based BFR in case of beam failure is detected/declared on the Spcell. In some embodiments, the case of beam alignment may be at least one of: a mode of joint TCI, the source RS for qcl-TypeD in the indicated/activated/applied DL TCI is same as the source RS for spatial relation in the indicated/activated/applied UL TCI and the source RS for qcl-TypeD in the indicated/activated/applied DL TCI is QCLed with the source RS for spatial relation in the indicated/activated/applied UL TCI. For example, QCLed with qcl-typeD.

In some embodiments, if the terminal device 120 is configured with a mode of separate DL/UL TCI on the Spcell, and if the indicated/activated/applied DL TCI and the indicated/activated/applied UL TCI is not a case of beam alignment, the terminal device 120 may transmit a PUCCH based on spatial relation information corresponding to a previous or latest indicated/activated/applied UL TCI.

In some embodiments, the RS set for candidate beam identification may at least include the RS configured in activated TCI states.

In some embodiments, the terminal device 120 may be configured with a set of TCI states on the first cell. In some embodiments, there may be at least one TCI state (e.g. represented as TCI_N) in the set, and the source RS configured in the TCI state may be associated with the second physical cell ID or associated with SSB with the second physical cell ID. In some embodiments, there may be at least one TCI state (e.g. represented as TCI_S) in the set, and the source RS configured in the TCI state may be associated with the first physical cell ID or associated with SSB with the first physical cell ID.

In some embodiments, if the TCI_N is indicated/activated, the TCI_N may be applied to at least UE dedicated channel/RS on the first cell. In some embodiments, if the TCI_N is indicated/activated, the TCI_N may not be applied on the second cell or the second list of cells. For example, the second cell or the second list of cells may be suspended. For example, there may be no channel/RS monitoring or receiving on the second cell or the second list of cells. For example, until a new TCI state which is associated with the first physical cell ID is indicated. In some embodiments, if the TCI_N is indicated/activated, a previous or a latest indicated/activated/applied TCI state which is associated with the first physical cell ID may be applied for at least UE dedicated channel/RS on the second cell or the second list of cells.

In some embodiments, if qnew is an SSB, the terminal device 120 may not monitor or receive channel/RS on the second list of cells. For example, the second cell or the second list of cells may be suspended. For example, until a new TCI state is indicated/activated and/or after application timing.

In some embodiments, if there is an RS (with same index of RS in TCI_N associated with the second physical cell ID on a third cell in the second list of cells, the TCI_N may be applied on the third cell. For example, otherwise, the TCI_N may not be applied on the third cell.

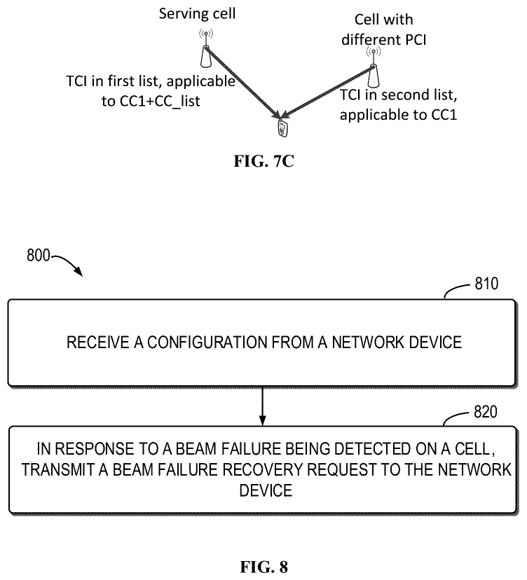

FIGS. 7A-7C illustrate examples in accordance with some embodiments of the present disclosure.

As shown in FIG. 7A, the terminal device 120 may be configured with a mode of separate DL/UL TCI, and configured with a non beam alignment case.

As shown in FIG. 7B, the terminal device 120 may be configured with a first list of TCI states and a second list of TCI states on the first cell (e.g. CC1). For example, the first list of TCI states may be associated with the first physical cell ID or associated with the serving cell. For example, the second list of TCI states may be associated with the second physical cell ID or associated with cell with different physical cell ID (PCI). And the terminal device 120 may be configured with the second list of cells (e.g. CC_list), and the CC_list may be configured to refer to the CC1.

As shown in FIG. 7C, the TCI states in the first list may be applicable to the first cell and the second list of cells. And the TCI states in the second list may be applicable to the first cell. For example, not applicable to the second list of cells.

In some embodiments, the terminal device 120 may be indicated/activated with TCI_N. For example, after the application timing. In some embodiments, the terminal device 120 may perform no beam failure recovery procedure on the first cell. In some embodiments, the terminal device 120 may perform the first beam failure recovery procedure for the first cell and/or the second cell and/or the second list of cells according to some embodiments in this disclosure.

In some embodiments, the parameters for the first beam failure recovery procedure may be based on at least one configuration on the first cell or based on the maximum/minimum value between configuration on the first cell and configuration the second cell or among the configurations on the first list of cells or among the configurations on the second list of cells. In some embodiments, the parameters may include at least one of: beamFailureInstanceMaxCount; beamFailureDetection Timer and rsrp-Threshold, candidateBeamRSList.

In some embodiments, beam failure detection (BFD) RS set for the first beam failure recovery procedure may be determined based on the RS configured with qcl-typeD in the first TCI state on the first cell or the BFD RS set may be determined based on RS in TCI states for respective CORESETs on the first cell. For example, the terminal device 120 may not expect the source RS (e.g. CSI-RS for channel state information (CSI) as source RS) for qcl-typeD in the first TCI state is not 1 and/or 2 ports. For example, if source RS for qcl-typeD in the first TCI state is not 1 and/or 2 ports, the first beam failure recovery (BFR) may be suspended or stopped. For example, if source RS for qcl-typeD in the first TCI state is not 1 and/or 2 ports, the terminal device 120 may determine a CSI-RS with 1 and/or 2 ports to be BFD RS. And the CSI-RS may be a source RS for qcl-typeD for the source RS in the first TCI state is applied for BFD RS. In some embodiments, the beam failure detection RS is based on BFD RS set configured in the first cell. In some embodiments, the beam failure detection RS may be determined based on the RS associated with the first physical cell ID.

In some embodiments, if beam failure is declared, values of beam failure indication field in MAC CE may be same for the first cell and the second cell.

In some embodiments, a new beam or RS may be identified from a candidate beam RS list. For example, the new beam or RS may be for both the first cell and the second cell or for the first list of cells or for the second list of cells. In some embodiments, the candidate beam RS list may be configured in first cell or may be a common candidate beam RS list configured for the first cell and the second cell or for the first list of cells or for the second list of cells. In some embodiments, in the MAC CE, presence of new beam or RS and index(es) of the new beam or RS may be same for the first cell and the second cell or for the first list of cells or for the second list of cells.

In some embodiments, the RS set for candidate beam identification may be associated with the first physical cell ID. In some embodiments, the RS set for candidate beam identification may include at least one of CSI-RS associated with the first physical cell ID and SSB associated with the first physical cell ID. In some embodiments, the terminal device 120 may transmit beam failure recovery request to the cell with the first physical cell ID and/or the cell with the second physical cell ID.

In some embodiments, the RS set for candidate beam identification may include at least one of: CSI-RS associated with the first physical cell ID, SSB associated with the first physical cell ID, CSI-RS associated with the second physical cell ID and SSB associated with the second physical cell ID.

In some embodiments, the RS set for candidate beam identification may only include at least one CSI-RS. For example, the RS set for candidate beam identification may not include SSB. In some embodiments, the RS set for candidate beam identification may include at least one of: CSI-RS associated with the first physical cell ID, CSI-RS associated with the second physical cell ID.

In some embodiments, if qnew is associate with the second physical cell ID, the qnew may not be applied to the second list of cells.

In some embodiments, there may be two sets of RS for candidate beam identification on the first cell. For example, a first set of RS and a second set of RS. In some embodiments, if the terminal device 120 is indicated with TCI_N, beam failure recovery procedure may be performed based on the second set of RS. In some embodiments, if the terminal device 120 is indicated with TCI_S, beam failure recovery procedure may be performed based on the first set of RS. In some embodiments, the RS in the first set of RS may be associated with the first physical cell ID. In some embodiments, the RS in the second set of RS may be associated with the second physical cell ID and/or the first physical cell ID.

In some embodiments, the terminal device 120 may monitor PDCCH on the first cell and the second cell after the first timing, and the PDCCH may be based on the QCL parameters associated with qnew.

In some embodiments, qnew may replace the source RS configured in the first TCI state or qnew may replace the first TCI state in the corresponding TCI codepoint after the first beam failure recovery procedure is successful. For example, until a new TCI state is indicated/activated for the first cell and second cell. For example, the qnew may be a periodic CSI-RS. For example, the number of ports for qnew may be 1 or 2 ports. In some embodiments, if qnew is a synchronization signal (SS)/physical broadcast channel (PBCH), qnew may not replace the source RS configured in the first TCI state.

In some embodiments, the terminal device 120 may receive an indication/activation of a second TCI state, and the field of cell information in source RS and QCL info in the second TCI state on the second cell may be absent. The terminal device 120 may perform a second beam failure recovery procedure on the second cell. For example, the second beam failure recovery procedure may be separate from the first beam failure recovery procedure. In some embodiments, the beam failure detection RS may be configured on the second cell or determined based on the RS on the second cell. For example, the RS may be configured in the second TCI state and for source RS and QCL info configured with qcl-TypeD. In some embodiments, the parameters for the second beam failure recovery procedure may be configured on the second cell. In some embodiments, the RS set for candidate beam identification for the second beam failure recovery procedure may be configured on the second cell or configured on the first cell or configured for the first/second list of cells. In some embodiments, there may be a plurality of TCI states configured on the second cell, and at least the source RS for qcl-TypeD or spatial reception parameter for different TCI states may refer to different cells, the RS set for candidate beam identification for the second beam failure recovery procedure may be the RS set configured on the cell with lowest ID among the different cells.

In some embodiments, the terminal device 120 may be indicated/activated with the TCI_N. For example, after the application timing. In some embodiments, the terminal device 120 may not be required to monitor paging and short message based on QCL parameters corresponding to TCI_N. In some embodiments, the terminal device 120 may monitor paging and short message in CSS (e.g. TypeD CSS) or USS based on QCL parameters corresponding to TCI_N. In some embodiments, if the terminal device 120 receives information broadcast channel (BCCH) modification, the terminal device 120 may not be required to monitor PDCCH scrambled with SI-RNTI based on QCL parameters corresponding to TCI_N or the terminal device 120 may ignore the information. In some embodiments, the terminal device 120 may monitor the PDCCH in monitoring occasion(s) based on the index of SSB which is associated with TCI_N. In some embodiments, the terminal device 120 may monitor in monitoring occasion(s) based on the index of SSB which is associated with a previous or latest TCI which is associated with the first physical cell ID. In some embodiments, the DMRS sequence for the PDCCH may be scrambled based on the value of the second physical cell ID. In some embodiments, the DMRS sequence for the PDCCH may be scrambled based on the value of the first physical cell ID.

In some embodiments, the terminal device 120 may be configured with a mode of non codebook based uplink transmission. In some embodiments, the terminal device 120 may be configured with two CSI-RS (e.g. a first CSI-RS and a second CSI-RS) and two SRS resource set (e.g. a first SRS resource set and a second SRS resource set) for non codebook based uplink transmission. For example, the first CSI-RS may be associated with the first SRS resource set. For example, the second CSI-RS may be associated with the second SRS resource set.

In some embodiments, if both of the first and the second SRS resource sets are triggered in an overlapped manner in time domain. For example, the overlapped manner may refer to overlapping of minimal gaps between the two pairs of associated NZP-CSI-RS and SRS corresponding to the two SRS resource sets. In some embodiments, the terminal device 120 may not be expected to update the SRS precoding information if the gap from the last symbol of the reception of the first CSI-RS resource and the first symbol of the SRS transmission corresponding to the first SRS resource set is less than 42 OFDM symbols. In some embodiments, the terminal device 120 may not be expected to update the SRS precoding information if the gap from the last symbol of the reception of the second CSI-RS resource and the first symbol of the SRS transmission corresponding to the second SRS resource set is less than 42+d OFDM symbols. For example, d may be a non negative integer. For example, 0<=d<=42. For example, d may be the number of overlapped symbols for the two pairs for CSI-RS and SRS. In some embodiments, the first symbol of the first CSI-RS resource may be earlier or no later than the second CSI-RS resource in time domain. In some embodiments, the index of the first CSI-RS resource may be lower or no larger than the index of the second CSI-RS resource. In some embodiments, the first symbol of the SRS in the first SRS resource set may be earlier or no later than the SRS in the second SRS resource set in time domain. In some embodiments, the index of the first SRS resource set may be lower or no larger than the index of the second SRS resource set.

FIG. 8 illustrates a flowchart of an example method 800 in accordance with some embodiments of the present disclosure. For example, the method 800 can be implemented at the terminal device 120 as shown in FIG. 1.

At block 810, the terminal device 120 receives a configuration from a network device (for example, the network device 110 as shown in FIG. 1), where the configuration indicates that each of a group of cells serving the terminal device is associated with at least one of a plurality of TRPs (for example, the TRPs 130-1 and 130-2 as shown in FIG. 1) coupled with the network device.

At block 820, in response to a beam failure being detected on a cell in the group of cells, the terminal device 120 transmits a beam failure recovery request to the network device, where the beam failure recovery request comprises TRP information related to the beam failure detected on the cell.

In some embodiments, each of the plurality of TRPs may be represented by at least one of the following: a CORESET pool index; a CORESET group identifier; an identifier of a set of RSs for beam failure detection; an identifier of a set of RSs for new/candidate beam identification; spatial relation information; a SRS resource set; a TCI state; and a set of QCL parameters.

In some embodiments, the plurality of TRPs may comprise a first TRP and a second TRP, the group of cells may comprise a first subset of cells associated with the first TRP and a second subset of cells associated with the second TRP, the first subset of cells may be configured with a first set of RSs for beam failure detection and a first set of RSs for new/candidate beam identification, and the second subset of cells may be configured with a second set of RSs for beam failure detection and a second set of RSs for new/candidate beam identification.

In some embodiments, in response to a beam failure being detected based on the first set of RSs, the terminal device 120 may transmit a first beam failure recovery request to the network device, where the first beam failure recovery request at least comprises an indication of the first TRP or the first subset of cells. In response to a beam failure being detected based on the second set of RSs for beam failure detection, the terminal device 120 may transmit a second beam failure recovery request to the network device, where the second beam failure recovery request at least comprises an indication of the second TRP or the second subset of cells.

In some embodiments, the cell may be associated with the plurality of TRPs and the TRP information may indicate one of the plurality of TRPs related to the beam failure detected on the cell.

In some embodiments, the TRP information may comprise an indication of a TRP index common to all cells indicated in the beam failure recovery request.

In some embodiments, the TRP information may comprise an indication of a respective TRP index for each of cells indicated in the beam failure recovery request.

In some embodiments, the cell may be associated with the plurality of TRPs and the TRP information may comprise at least one of the following: first information indicating the number of TRPs related to the beam failure detected on the cell; second information indicating an index of one of the plurality of TRPs related to the beam failure detected on the cell; and third information indicating on which one of the plurality of TRPs a new beam is identified.

In some embodiments, the cell may be associated with the plurality of TRPs and the TRP information may comprise: first information indicating the number of TRPs related to the beam failure detected on the cell; and second information indicating a RS index for a new beam identified on one TRP of the plurality of TRPs, where the RS index indicates an index of the one TRP.

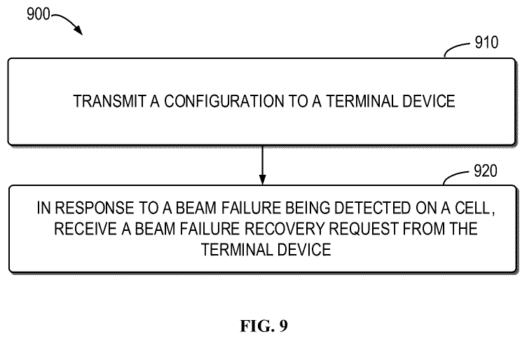

FIG. 9 illustrates a flowchart of an example method 900 in accordance with some embodiments of the present disclosure. For example, the method 900 can be implemented at the network device 110 as shown in FIG. 1.

At block 910, the network device 110 transmits a configuration to a terminal device (for example, the terminal device 120 as shown in FIG. 1), where the configuration indicates that each of a group of cells serving the terminal device is associated with at least one of a plurality of TRPs (for example, the TRPs 130-1 and 130-2 as shown in FIG. 1) coupled with the network device 110.

At block 920, in response to a beam failure being detected on a cell in the group of cells, the network device 110 receives a beam failure recovery request from the terminal device, where the beam failure recovery request comprises TRP information related to the beam failure detected on the cell.

In some embodiments, each of the plurality of TRPs may be represented by at least one of the following: a CORESET pool index; a CORESET group identifier; an identifier of a set of RSs for beam failure detection; an identifier of a set of RSs for new/candidate beam identification; spatial relation information; a SRS resource set; a TCI state; and a set of QCL parameters.

In some embodiments, the plurality of TRPs may comprise a first TRP and a second TRP, the group of cells may comprise a first subset of cells associated with the first TRP and a second subset of cells associated with the second TRP, the first subset of cells may be configured with a first set of RSs for beam failure detection and a first set of RSs for new/candidate beam identification, and the second subset of cells may be configured with a second set of RSs for beam failure detection and a second set of RSs for new/candidate beam identification.

In some embodiments, in response to a beam failure being detected based on the first set of RSs, the network device 110 may receive a first beam failure recovery request from the terminal device, where the first beam failure recovery request at least comprises an indication of the first TRP or the first subset of cells. In response to a beam failure being detected based on the second set of RSs for beam failure detection, the network device 110 may receive a second beam failure recovery request from the terminal device, where the second beam failure recovery request at least comprises an indication of the second TRP or the second subset of cells.

In some embodiments, the cell may be associated with the plurality of TRPs and the TRP information may indicate one of the plurality of TRPs related to the beam failure detected on the cell.

In some embodiments, the TRP information may comprise an indication of a TRP index common to all cells indicated in the beam failure recovery request.

In some embodiments, the TRP information may comprise an indication of a respective TRP index for each of cells indicated in the beam failure recovery request.

In some embodiments, the cell may be associated with the plurality of TRPs and the TRP information may comprise at least one of the following: first information indicating the number of TRPs related to the beam failure detected on the cell; second information indicating an index of one of the plurality of TRPs related to the beam failure detected on the cell; and third information indicating on which one of the plurality of TRPs a new beam is identified.

In some embodiments, the cell may be associated with the plurality of TRPs and the TRP information may comprise: first information indicating the number of TRPs related to the beam failure detected on the cell; and second information indicating a RS index for a new beam identified on one TRP of the plurality of TRPs, where the RS index indicates an index of the one TRP.

In some embodiments, a terminal device comprises circuitry configured to: receive a configuration from a network device, wherein the configuration indicates that each of a group of cells serving the terminal device is associated with at least one of a plurality of transmission and reception points (TRPs) coupled with the network device; and in response to a beam failure being detected on a cell in the group of cells, transmit a beam failure recovery request to the network device, wherein the beam failure recovery request comprises TRP information related to the beam failure detected on the cell.

In some embodiments, each of the plurality of TRPs is represented by at least one of the following: a control resource set (CORESET) pool index; a CORESET group identifier; an identifier of a set of reference signals (RSs) for beam failure detection; an identifier of a set of RSs for new/candidate beam identification; spatial relation information; a sounding reference signal (SRS) resource set; a transmission configuration indicator (TCI) state; and a set of quasi co-location parameters.

In some embodiments, the plurality of TRPs comprise a first TRP and a second TRP, the group of cells comprise a first subset of cells associated with the first TRP and a second subset of cells associated with the second TRP, the first subset of cells are configured with a first set of RSs for beam failure detection and a first set of RSs for new/candidate beam identification, and the second subset of cells are configured with a second set of RSs for beam failure detection and a second set of RSs for new/candidate beam identification.

In some embodiments, the terminal device comprises circuitry configured to: in response to a beam failure being detected based on the first set of RSs, transmit a first beam failure recovery request to the network device, wherein the first beam failure recovery request at least comprises an indication of the first TRP or the first subset of cells; and in response to a beam failure being detected based on the second set of RSs for beam failure detection, transmit a second beam failure recovery request to the network device, wherein the second beam failure recovery request at least comprises an indication of the second TRP or the second subset of cells.

In some embodiments, the cell is associated with the plurality of TRPs and the TRP information indicates one of the plurality of TRPs related to the beam failure detected on the cell.

In some embodiments, the TRP information comprises an indication of a TRP index common to all cells indicated in the beam failure recovery request.

In some embodiments, the TRP information comprises an indication of a respective TRP index for each of cells indicated in the beam failure recovery request.

In some embodiments, the cell is associated with the plurality of TRPs and the TRP information comprises at least one of the following: first information indicating the number of TRPs related to the beam failure detected on the cell; second information indicating an index of one of the plurality of TRPs related to the beam failure detected on the cell; and third information indicating on which one of the plurality of TRPs a new beam is identified.

In some embodiments, the cell is associated with the plurality of TRPs and the TRP information comprises: first information indicating the number of TRPs related to the beam failure detected on the cell; and second information indicating a RS index for a new beam identified on one TRP of the plurality of TRPs, wherein the RS index indicates an index of the one TRP.

In some embodiments, a network device comprises circuitry configured to: transmit a configuration from to a terminal device, wherein the configuration indicates that each of a group of cells serving the terminal device is associated with at least one of a plurality of transmission and reception points (TRPs) coupled with the network device; and in response to a beam failure being detected on a cell in the group of cells, receive a beam failure recovery request from the terminal device, wherein the beam failure recovery request comprises TRP information related to the beam failure detected on the cell.

In some embodiments, each of the plurality of TRPs is represented by at least one of the following: a control resource set (CORESET) pool index; a CORESET group identifier;
an identifier of a set of reference signals (RSS) for beam failure detection; an identifier of a set of RSs for new/candidate beam identification; spatial relation information; a sounding reference signal (SRS) resource set; a transmission configuration indicator (TCI) state; and a set of quasi co-location parameters.

In some embodiments, the plurality of TRPs comprise a first TRP and a second TRP, the group of cells comprise a first subset of cells associated with the first TRP and a second subset of cells associated with the second TRP, the first subset of cells are configured with a first set of RSs for beam failure detection and a first set of RSs for new/candidate beam identification, and the second subset of cells are configured with a second set of RSs for beam failure detection and a second set of RSs for new/candidate beam identification.

In some embodiments, the network device comprises circuitry configured to: in response to a beam failure being detected based on the first set of RSs, receive a first beam failure recovery request from the terminal device, wherein the first beam failure recovery request at least comprises an indication of the first TRP or the first subset of cells; and in response to a beam failure being detected based on the second set of RSs for beam failure detection, receive a second beam failure recovery request from the terminal device, wherein the second beam failure recovery request at least comprises an indication of the second TRP or the second subset of cells.

In some embodiments, the cell is associated with the plurality of TRPs and the TRP information indicates one of the plurality of TRPs related to the beam failure detected on the cell.

In some embodiments, the TRP information comprises an indication of a TRP index common to all cells indicated in the beam failure recovery request.

In some embodiments, the TRP information comprises an indication of a respective TRP index for each of cells indicated in the beam failure recovery request.

In some embodiments, the cell is associated with the plurality of TRPs and the TRP information comprises at least one of the following: first information indicating the number of TRPs related to the beam failure detected on the cell; second information indicating an index of one of the plurality of TRPs related to the beam failure detected on the cell; and third information indicating on which one of the plurality of TRPs a new beam is identified.

In some embodiments, the cell is associated with the plurality of TRPs and the TRP information comprises: first information indicating the number of TRPs related to the beam failure detected on the cell; and second information indicating a RS index for a new beam identified on one TRP of the plurality of TRPs, wherein the RS index indicates an index of the one TRP.

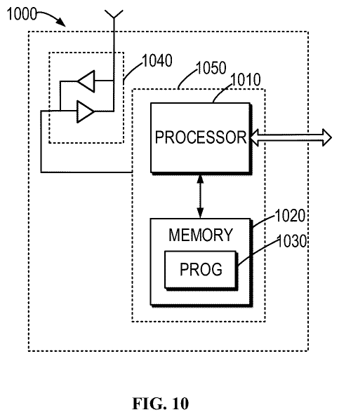

FIG. 10 is a simplified block diagram of a device 1000 that is suitable for implementing embodiments of the present disclosure. The device 1000 can be considered as a further example implementation of the network device 110, the TRP 130 and/or the terminal device 120 as shown in FIG. 1. Accordingly, the device 1000 can be implemented at or as at least a part of the network device 110, the TRP 130 and/or the terminal device 120 as shown in FIG. 1.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the CNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIG. 1 to FIG. 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 10 and 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-21. (canceled)

22. A method of communication, comprising:
receiving, at a terminal device, from a network device, at least one configuration for a set of transmission configuration indicator (TCI) states, wherein the set of TCI states comprises at least one of:
a first subset of TCI states, wherein at least one reference signal (RS) in a TCI state of the first subset is associated with a first physical cell identity (ID); and
a second subset of TCI states, wherein at least one RS in a TCI state of the second subset is associated with a second physical cell ID;
performing a beam failure recovery procedure based on at least one of a first set of RS for beam failure detection and a first set of RS for candidate beam identification, in case of a first TCI state of the first subset is indicated; and
performing a beam failure recovery procedure based on at least one of a second set of RS for beam failure detection and a second set of RS for candidate beam identification, in case of a second TCI state of the second subset is indicated.

23. The method of claim 22, wherein the at least one configuration for the set of TCI states is configured for a first cell, wherein the first cell is associated with the first physical cell ID.

24. The method of claim 22, further comprising at least one of:
the first set of RS for beam failure detection is associated with the first physical cell ID;
the first set of RS for candidate beam identification is associated with the first physical cell ID;
the second set of RS for beam failure detection is associated with the second physical cell ID; and
the second set of RS for candidate beam identification is associated with the first physical cell ID and/or the second physical cell ID.

25. The method of claim 22, further comprising at least one of:
the first set of RS for beam failure detection is configured on the first cell;
the first set of RS for beam failure detection is determined based on at least one TCI state for a first set of control resource sets (CORESETs) on the first cell, wherein the at least one TCI state is associated with the first physical cell ID and/or the second physical cell ID;
the first set of RS for beam failure detection is determined based on the first TCI state;
the first set of RS for candidate beam identification is configured on the first cell;
the second set of RS for beam failure detection is configured on the first cell;
the second set of RS for beam failure detection is determined based on at least one TCI state for a second set of control resource sets (CORESETs) on the first cell, wherein the at least one TCI state is associated with the first physical cell ID and/or the second physical cell ID;
the second set of RS for beam failure detection is determined based on the second TCI state; and
the second set of RS for candidate beam identification is configured on the first cell.

26. The method of claim 22, further comprising:
receiving at least one configuration for a first list of cells, wherein the first list of cells comprises the first cell and a second list of cells, and at least a first spatial reception parameter of the second list of cells refers to the first cell based on the at least one configuration for the first list of cells.

27. The method of claim 22, in response to the first TCI state is indicated, further comprising at least one of:
monitoring or receiving at least one physical downlink control channel (PDCCH) in corresponding CORESETs on at least one cell in the first list of cells based on the first TCI state after or starting from an application timing;
receiving at least one physical downlink shared channel (PDSCH) on at least one cell in the first list of cells based on the first TCI state after or starting from the application timing, wherein the at least one PDSCH is scheduled by the at least one PDCCH;
transmitting a physical uplink control channel (PUCCH) on the first cell based on the first TCI state after or starting from the application timing; and
transmitting at least one physical uplink shared channel (PUSCH) on at least one cell in the first list of cells based on the first TCI state after or starting from the application timing.

28. The method of claim 22, in response to the second TCI state is indicated, further comprising at least one of:
monitoring or receiving at least one PDCCH in corresponding CORESETs on the first cell based on the second TCI state after or starting from the application timing;
receiving at least one PDSCH on the first cell based on the second TCI state after or starting from the application timing, wherein the at least one PDSCH is scheduled by the at least one PDCCH;
transmitting a PUCCH on the first cell based on the second TCI state after or starting from the application timing; and
transmitting at least one PUSCH on the first cell based on the second TCI state after or starting from the application timing.

29. The method of claim 22, in response to the second TCI state is indicated, further comprising at least one of:
performing no monitoring or receiving or transmitting on the second list of cells after or starting from the application timing;
monitoring or receiving at least one PDCCH in corresponding CORESETs on at least one cell in the second list of cells based on a latest or previous TCI state;
receiving at least one PDSCH on at least one cell in the second list of cells based on the latest or previous TCI state; and
transmitting at least one PUSCH on at least one cell in the second list of cells based on the latest or previous TCI state, wherein the latest or previous TCI state is associated with the first physical cell ID.

30. The method of claim 22, wherein the application timing is a first slot which is a number of symbols after a last symbol of an acknowledgement corresponding to a PDCCH or a PDSCH scheduled by the PDCCH, wherein the first TCI state or the second TCI state is indicated in the PDCCH.

31. A method of communication, comprising:
transmitting, at a network device, to a terminal device, at least one configuration for a set of transmission configuration indicator (TCI) states, wherein the set of TCI states comprises at least one of:
a first subset of TCI states, wherein at least one reference signal (RS) in a TCI state of the first subset is associated with a first physical cell identity (ID); and
a second subset of TCI states, wherein at least one RS in a TCI state of the second subset is associated with a second physical cell ID, wherein the at least one configuration for the set of TCI states is configured for a first cell, wherein the first cell is associated with the first physical cell ID;
transmitting at least one configuration for a first list of cells, wherein the first list of cells comprises the first cell and a second list of cells, and at least a first spatial reception parameter of the second list of cells refers to the first cell based on the at least one configuration for the first list of cells;
in response to a first TCI state in the first subset is indicated, transmitting at least one downlink channel and/or receiving at least one uplink channel on at least one cell in the first list of cells based on the first TCI state after or starting from an application timing; and
in response to a second TCI state in the second subset is indicated, performing no transmitting or receiving on the second list of cells after or starting from the application timing; or
in response to a second TCI state in the second subset is indicated, transmitting at least one downlink channel and/or receiving at least one uplink channel on at least one cell in the second list of cells based on a latest or previous TCI state, wherein the latest or previous TCI state is associated with the first physical cell ID.

32-33. (canceled)
